(19) United States
(12) Patent Application Publication
(10) Pub. No.: US 2017/0005378 A1
(43) Pub. Date: Jan. 5, 2017

(54) BATTERY PACK FOR VEHICLE ENERGY-STORAGE SYSTEMS

(71) Applicant: Faraday&Future Inc., Gardena, CA (US)

(72) Inventor: Jiepeng Rong, Pasadena, CA (US)

(21) Appl. No.: 15/143,346

(22) Filed: Apr. 29, 2016

Related U.S. Application Data
(63) Continuation of application No. 15/011,325, filed on Jan. 29, 2016.
Application No. 15/011,325 is a continuation-in-part of application No. 14/946,699, filed on Nov. 19, 2015.
Application No. 14/946,699 is a continuation-in-part of application No. 14/841,617, filed on Aug. 31, 2015.
(60) Provisional application No. 62/186,977, filed on Jun. 30, 2015.

(51) Int. Cl. H01M 10/625; H01M 10/6567; H01M 10/643; H01M 10/0525; H01M 10/613

(52) U.S. Cl. CPC H01M 10/625; H01M 10/0525; H01M 10/613; H01M 10/643; H01M 10/6567; H01M 2220/20

(57) ABSTRACT

Provided are battery packs. Each pack may comprise a first plurality of strings electrically coupled to each other in parallel, each of the first plurality of strings providing substantially an output voltage and comprising: a first plurality of battery modules comprising: a plurality of high power battery cells, each of the plurality of high power battery cells having a higher power specification than a plurality of high energy battery cells; and a second plurality of strings electrically coupled to each other and to the first plurality of strings in parallel, each of the second plurality of strings providing substantially the output voltage and comprising: a second plurality of battery modules comprising: the plurality of high energy battery cells, each of the plurality of high power battery cells having a higher energy specification than the plurality of high power battery cells.

### CROSS-REFERENCE TO RELATED APPLICATION

This application is a continuation-in-part of U.S. patent application Ser. No. 14/946,699, filed on Nov. 19, 2015, which is a continuation-in-part of U.S. patent application Ser. No. 14/841,617, filed on Aug. 31, 2015, which claims the benefit of U.S. Provisional Application No. 62/186,977, filed on Jun. 30, 2015. The subject matter of the aforementioned applications is incorporated herein by reference for all purposes.

### FIELD

The present application relates generally to energy-storage systems, and more specifically to energy-storage systems for vehicles.

### BACKGROUND

It should not be assumed that any of the approaches described in this section qualify as prior art merely by virtue of their inclusion in this section.

Electric-drive vehicles offer a solution for reducing the impact of fossil-fuel engines on the environment and transforming automotive mobility into a sustainable mode of transportation. Energy-storage systems are essential for electric-drive vehicles, such as hybrid electric vehicles, plug-in hybrid electric vehicles, and all-electric vehicles. However, present energy-storage systems have disadvantages including large size, inefficiency, and poor safety, to name a few. Similar to many sophisticated electrical systems, heat in automotive energy-storage systems should be carefully managed. Current thermal management schemes consume an inordinate amount of space. Present energy-storage systems also suffer from inefficiencies arising variously from imbalance among battery cells and resistance in various electrical connections. In addition, current energy-storage systems are not adequately protected from forces such as crash forces encountered during a collision.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to various embodiments, the present disclosure may be directed to battery packs comprising: a first plurality of strings electrically coupled to each other in parallel, each of the first plurality of strings providing substantially a first output voltage and comprising: a first plurality of battery modules electrically coupled to each other in series, each of the first plurality of battery modules providing substantially a second output voltage and comprising: a plurality of high power battery cells, each of the plurality of high power battery cells providing substantially a third output voltage and having a higher power specification than a plurality of high energy battery cells; and a second plurality of strings electrically coupled to each other and to the first plurality of strings in parallel, each of the second plurality of strings providing substantially the first output voltage and comprising: a second plurality of battery modules electrically coupled to each other in series, each of the second plurality of battery modules providing substantially the second output voltage and comprising: the plurality of high energy battery cells, each of the plurality of high power battery cells providing substantially the third output voltage and having a higher energy specification than the plurality of high power battery cells.

### BRIEF DESCRIPTION OF THE DRAWINGS

Embodiments are illustrated by way of example and not limitation in the figures of the accompanying drawings, in which like references indicate similar elements. It will be understood that the figures are not necessarily to scale and that details not necessary for an understanding of the technology or that render other details difficult to perceive may be omitted.

FIG. 1 illustrates an example environment in which an energy-storage system can be used.

FIG. 2A shows an orientation of battery modules in an energy-storage system, according to various embodiments of the present disclosure.

FIG. 2B depicts a bottom part of an enclosure of a partial battery pack such as shown in FIG. 2A.

FIG. 3 is a simplified diagram illustrating coolant flows, according to example embodiments.

FIG. 4 is a simplified diagram of a battery module, according to various embodiments of the present disclosure.

FIG. 5 illustrates a half module, in accordance with various embodiments.

FIGS. 6A and 6B show a current carrier, according to various embodiments.

FIG. 7 depicts an example battery cell.

FIGS. 8 and 9 illustrate further embodiments of a battery module.

FIGS. 10A and 10B show battery module coupling, according to some embodiments.

FIG. 11 depicts an exploded view of a battery module, in accordance with various embodiments.

FIGS. 12A-C depict various perspective views of a blast plate, according to some embodiments.

FIG. 13 illustrates a half shell, according to various embodiments.

FIG. 14 depicts a cross-sectional view of a battery module, in accordance with some embodiments.

FIG. 15 shows a simplified flow diagram for a process for assembling a battery module, according to some embodiments.

FIG. 16 illustrates a simplified view of a battery pack according to various embodiments.

FIG. 17 depicts example characteristics of battery cells in accordance with some embodiments.

FIG. 18 shows example battery pack configurations according to some embodiments.

### DETAILED DESCRIPTION

While this technology is susceptible of embodiment in many different forms, there are shown in the drawings and will herein be described in detail several specific embodiments, with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise. It will be further understood that the terms “comprises,” “comprising,” “includes,” and “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

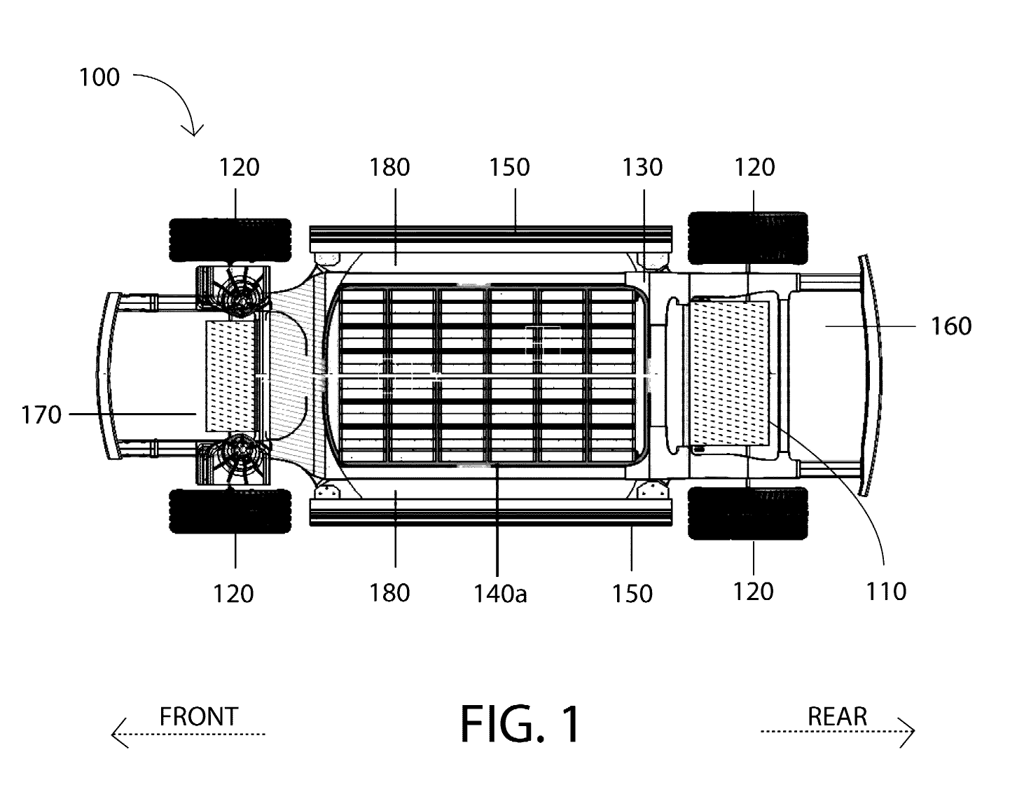

Some embodiments of the present invention can be deployed in a wheeled, self-powered motor vehicle used for transportation, such as hybrid electric vehicles, plug-in hybrid electric vehicles, and all-electric vehicles. For example, FIG. 1 illustrates an electric car 100. Electric car 100 is an automobile propelled by one or more electric motors 110. Electric motor 110 can be coupled to one or more wheels 120 through a drivetrain (not shown in FIG. 1). Electric car 100 can include a frame 130 (also known as an underbody or chassis). Frame 130 is a supporting structure of electric car 100 to which other components can be attached/mounted, such as, for example, a battery pack 140a. Battery pack 140a can supply electricity to power one or more electric motors 110, for example, through an inverter. The inverter can change direct current (DC) from battery pack 140a to alternating current (AC), as required for electric motors 110, according to some embodiments.

As depicted in FIG. 1, battery pack 140a may have a compact “footprint” and be at least partially enclosed by frame 130 and disposed to provide a predefined separation, e.g. from structural rails 150 of an upper body that couples to frame 130. Accordingly, at least one of a rear crumple zone 160, a front crumple zone 170, and a lateral crumple zone 180 can be formed around battery pack 140a. Both the frame 130 and structural rails 150 may protect battery pack 140a from forces or impacts exerted from outside of electric car 100, for example, in a collision. In contrast, other battery packs which extend past at least one of structural rails 150, rear crumple zone 160, and front crumple zone 170 remain vulnerable to damage and may even explode in an impact.

Battery pack 140a may have a compact “footprint” such that it may be flexibly used in and disposed on frame 130 having different dimensions. Battery pack 140a can also be disposed in frame 130 to help improve directional stability (e.g., yaw acceleration). For example, battery pack 140a can be disposed in frame 130 such that a center of gravity of electric car 100 is in front of the center of the wheelbase (e.g., bounded by a plurality of wheels 120).

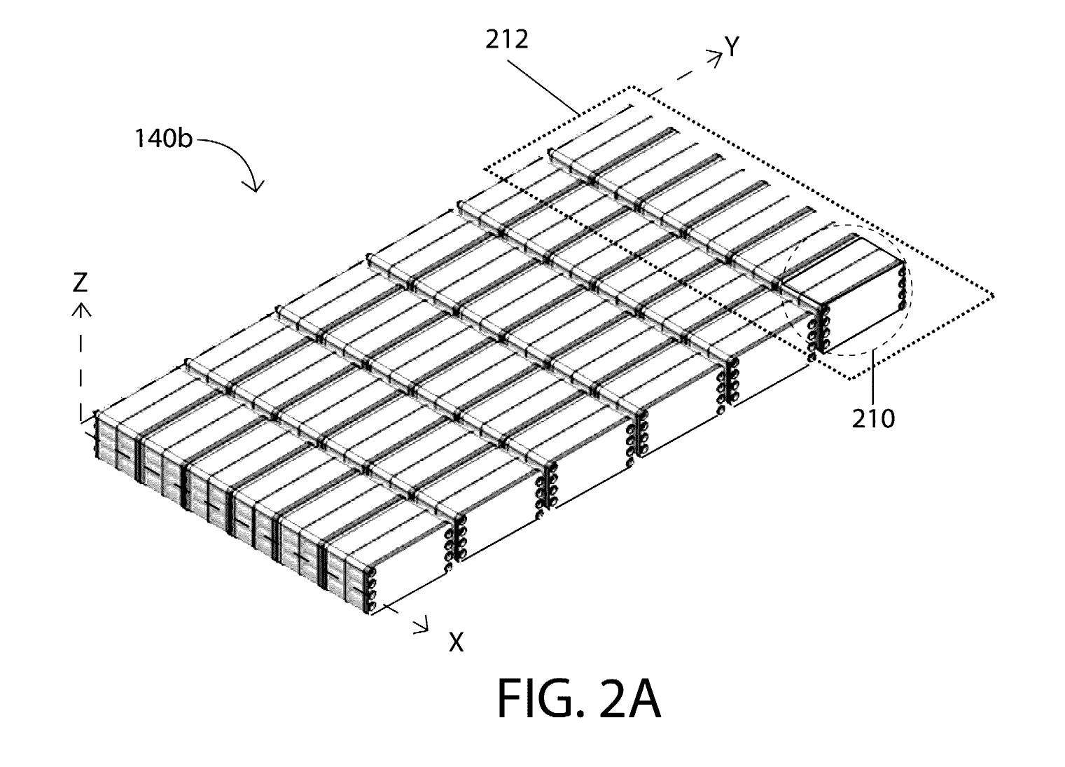

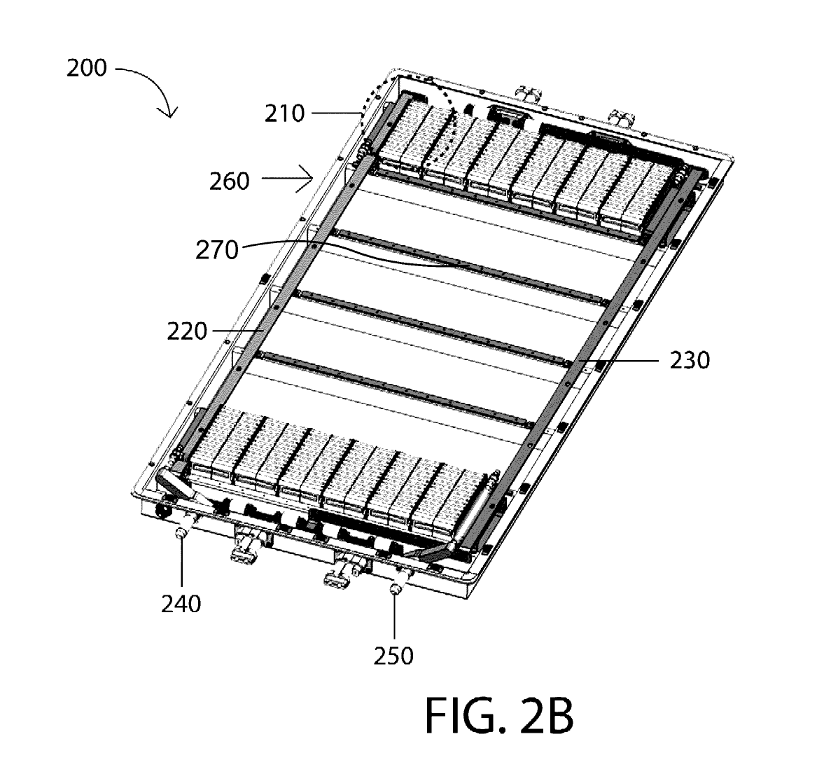

FIG. 2A shows a battery pack 140b with imaginary x-, y-, and z-axis superimposed, according to various embodiments. Battery pack 140b can include a plurality of battery modules 210. In the non-limiting example, battery pack 140b can be approximately 1000 mm wide (along x-axis), 1798 mm long (along y-axis), and 152 mm high (along z-axis), and can include 36 of battery modules 210.

FIG. 2B illustrates an exemplary enclosure 200 for battery pack 140b having a cover removed for illustrative purposes. Enclosure 200 includes tray 260 and a plurality of battery modules 210. The tray 260 may include a positive bus bar 220 and a negative bus bar 230. Positive bus bar 220 can be electrically coupled to a positive (+) portion of a power connector of each battery module 210. Negative bus bar 230 can be electrically coupled to a negative (−) portion of a power connector of each battery module 210. Positive bus bar 220 is electrically coupled to a positive terminal 240 of enclosure 200. Negative bus bar 230 can be electrically coupled to a negative terminal 250 of enclosure 200. As described above with reference to FIG. 1, because bus bars 220 and 230 are within structural rails 150, they can be protected from collision damage.

According to some embodiments, negative bus bar 230 and positive bus bar 220 are disposed along opposite edges of tray 260 to provide a predefined separation between negative bus bar 230 and positive bus bar 220. Such separation between negative bus bar 230 and positive bus bar 220 can prevent or at least reduce the possibility of a short circuit (e.g., of battery pack 140b) due to a deformity caused by an impact.

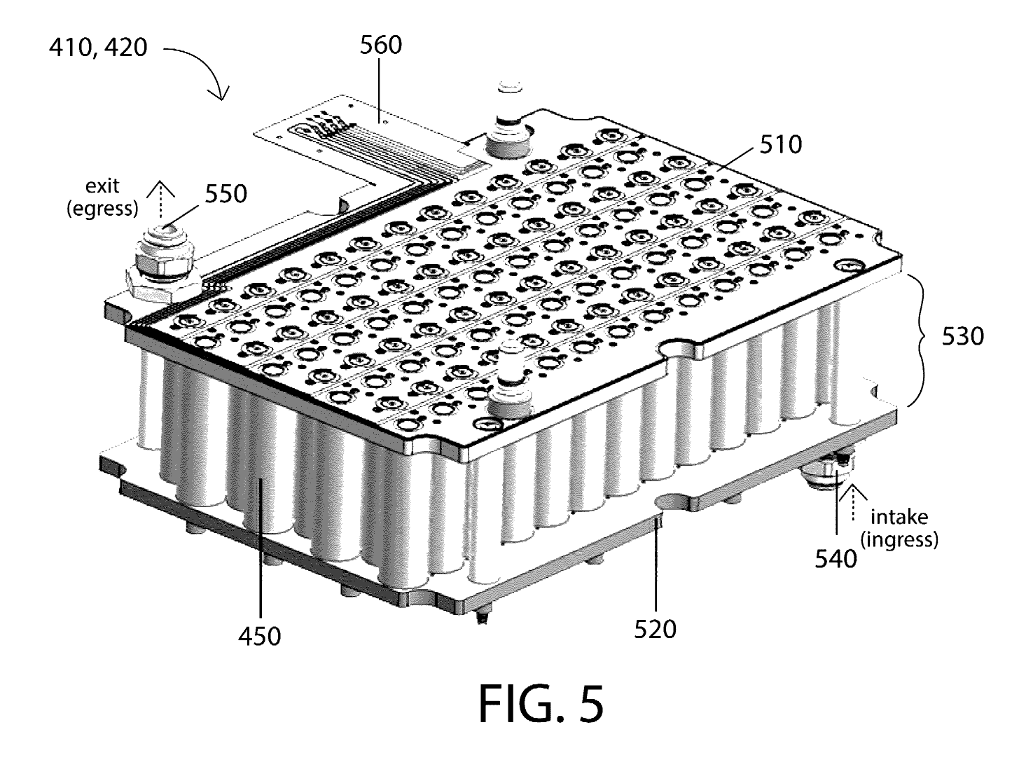

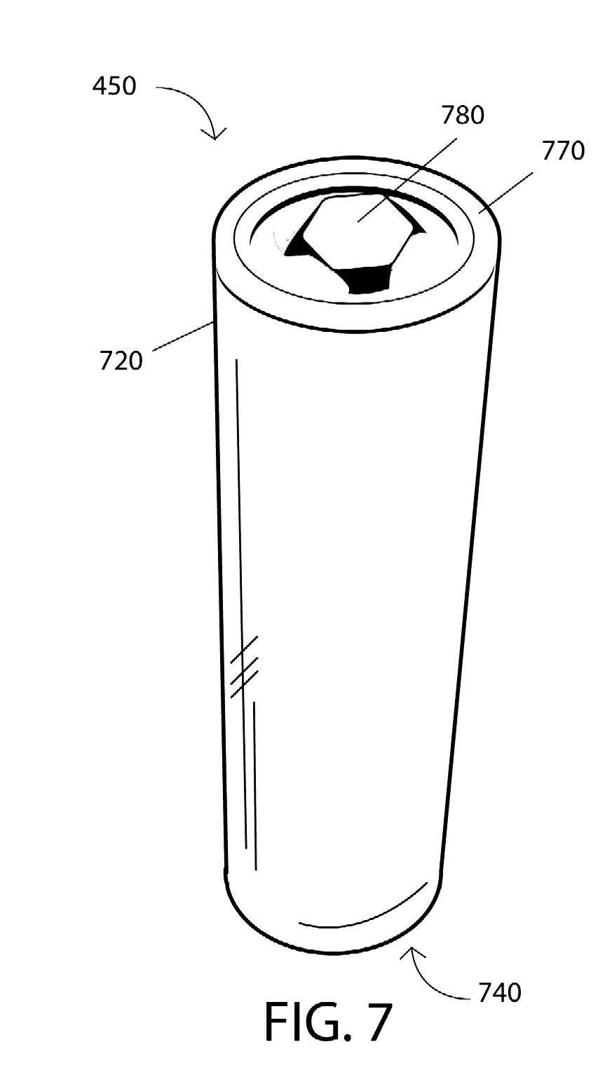

As will be described further in more detail with reference to FIG. 5, battery module 210 can include at least one battery cell (details not shown in FIG. 2A, see FIG. 7). The at least one battery cell can include an anode terminal, a cathode terminal, and a cylindrical body. The battery cell can be disposed in each of battery module 210 such that a surface of the anode terminal and a surface of the cathode terminal are normal to the imaginary x-axis referenced in FIG. 2A (e.g., the cylindrical body of the battery cell is parallel to the imaginary x-axis). This can be referred to as an x-axis cell orientation.

In the event of fire and/or explosion in one or more of battery modules 210, the battery cells can be vented along the x-axis, advantageously minimizing a danger and/or a harm to a driver, passenger, cargo, and the like, which may be disposed in electric car 100 above battery pack 140b (e.g., along the z-axis), in various embodiments.

The x-axis cell orientation of battery modules 210 in battery pack 140b shown in FIGS. 2A and 2B can be advantageous for efficient electrical and fluidic routing to each of battery module 210 in battery pack 140b. For example, at least some of battery modules 210 can be electrically connected in a series forming string 212, and two or more of string 212 can be electrically connected in parallel. This way, in the event one of string 212 fails, others of string 212 may not be affected, according to various embodiments.

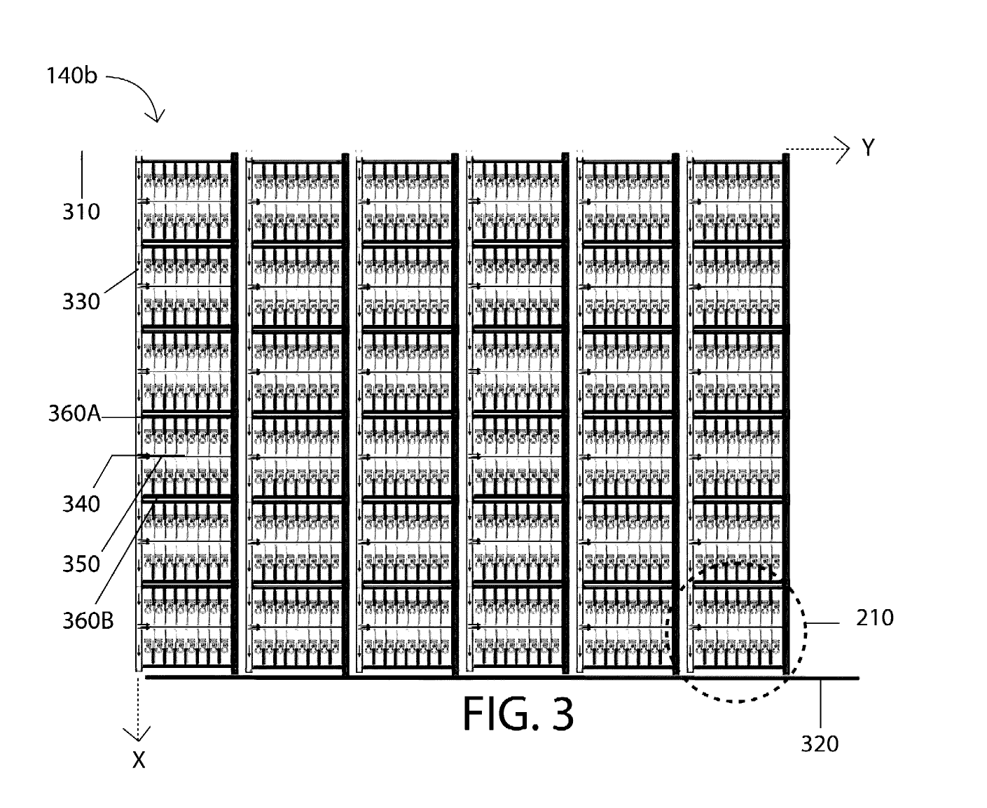

FIG. 3 illustrates coolant flows and operation of a coolant system and a coolant sub-system according to various embodiments. As shown in FIG. 3, the x-axis cell orientation can be advantageous for routing coolant (cooling fluid) in parallel to each of battery modules 210 in battery pack 140b. Coolant can be pumped into battery pack 140b at ingress 310 and pumped out of battery pack 140b at egress 320. A resulting pressure gradient within battery pack 140b can provide sufficient circulation of coolant to minimize a temperature gradient within battery pack 140b (e.g., a temperature gradient within one of battery modules 210, a temperature gradient between battery modules 210, and/or a temperature gradient between two or more of string 212 shown in FIG. 2A).

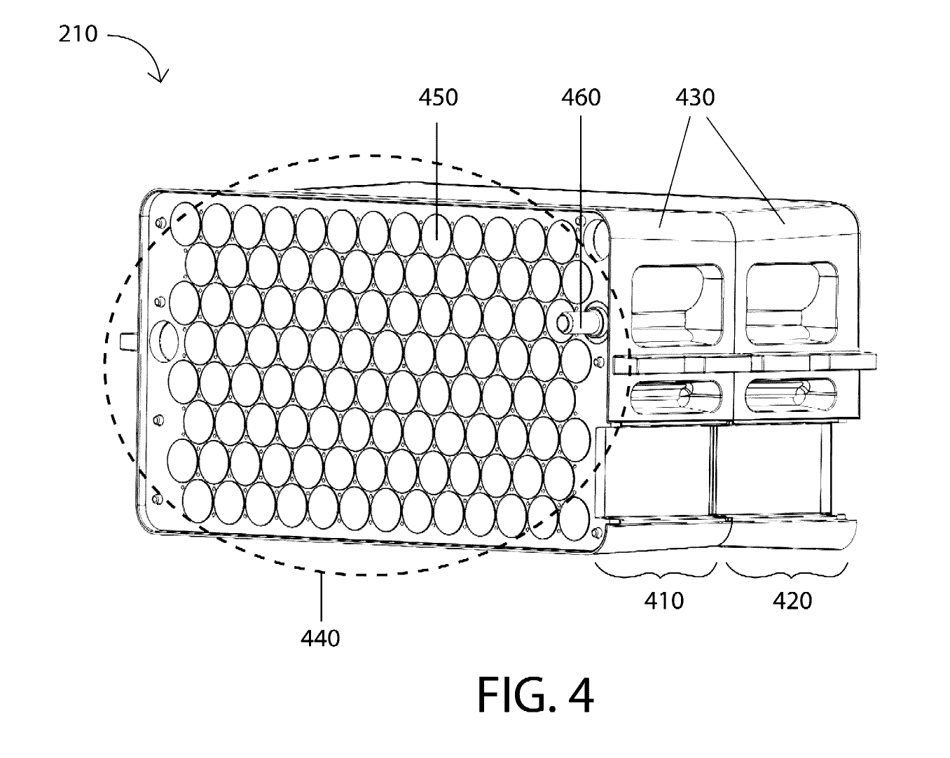

Within battery pack 140b, the coolant system may circulate the coolant, for example, to battery modules 210 (e.g., the circulation is indicated by reference numeral 330). One or more additional pumps (not shown in FIG. 3) can be used to maintain a roughly constant pressure between multiple battery modules 210 connected in series (e.g., in string 212 in FIG. 2A) and between such strings. Within each battery module 210, the coolant sub-system may circulate the coolant, for example, between and within two half modules 410 and 420 shown in FIG. 4 (e.g., the circulation indicated by reference numeral 340). In some embodiments, the coolant can enter each battery module 210 through an interface 350 between two half modules 410 and 420, in a direction (e.g., along the y- or z-axis) perpendicular to the cylindrical body of each battery cell, and flow to each cell. Driven by pressure within the coolant system, the coolant then can flow along the cylindrical body of each battery (e.g., along the x-axis) and may be collected at the two (opposite) side surfaces 360A and 360B of the module that can be normal to the x-axis. In this way, heat can be efficiently managed/dissipated and thermal gradients minimized among all battery cells in battery pack 140b, such that a temperature may be maintained at an approximately uniform level.

In some embodiments, parallel cooling, as illustrated in FIG. 3, can maintain temperature among battery cells in battery pack 140b at an approximately uniform level such that a direct current internal resistance (DCIR) of each battery cell is maintained at an substantially predefined resistance. The DCIR can vary with a temperature, therefore, keeping each battery cell in battery pack 140b at a substantially uniform and predefined temperature can result in each battery cell having substantially the same DCIR. Since a voltage across each battery cell can be reduced as a function of its respective DCIR, each battery cell in battery pack 140b may experience substantially the same loss in voltage. In this way, each battery cell in battery pack 140b can be maintained at approximately the same capacity and imbalances between battery cells in battery pack 140b can be minimized.

In some embodiments, when compared to techniques using metal tubes to circulate coolant, parallel cooling can enable higher battery cell density within battery module 210 and higher battery module density in battery pack 140b. In some embodiments, coolant or cooling fluid may be at least one of the following: synthetic oil, water and ethylene glycol (WEG), poly-alpha-olefin (or poly-α-olefin, also abbreviated as PAO) oil, liquid dielectric cooling based on phase change, and the like. By way of further non-limiting example, the coolant may be at least one of: perfluorohexane (Flutec PP1), perfluoromethylcyclohexane (Flutec PP2), Perfluoro-1,3-dimethylcyclohexane (Flutec PP3), perfluorodecalin (Flutec PP6), perfluoromethyldecalin (Flutec PP9), trichlorofluoromethane (Freon 11), trichlorotrifluoroethane (Freon 113), methanol (methyl alcohol 283-403K), ethanol (ethyl alcohol 273-403K), and the like.

FIG. 4 illustrates battery module 210 according to various embodiments. A main power connector 460 can provide power from battery cells 450 to outside of battery module 210. In some embodiments, battery module 210 can include two half modules 410 and 420, each having an enclosure 430. Enclosure 430 may be made using one or more plastics having sufficiently low thermal conductivities. Respective enclosures 430 of each of the two half modules 410 and 420 may be coupled with each other to form the housing for battery module 210.

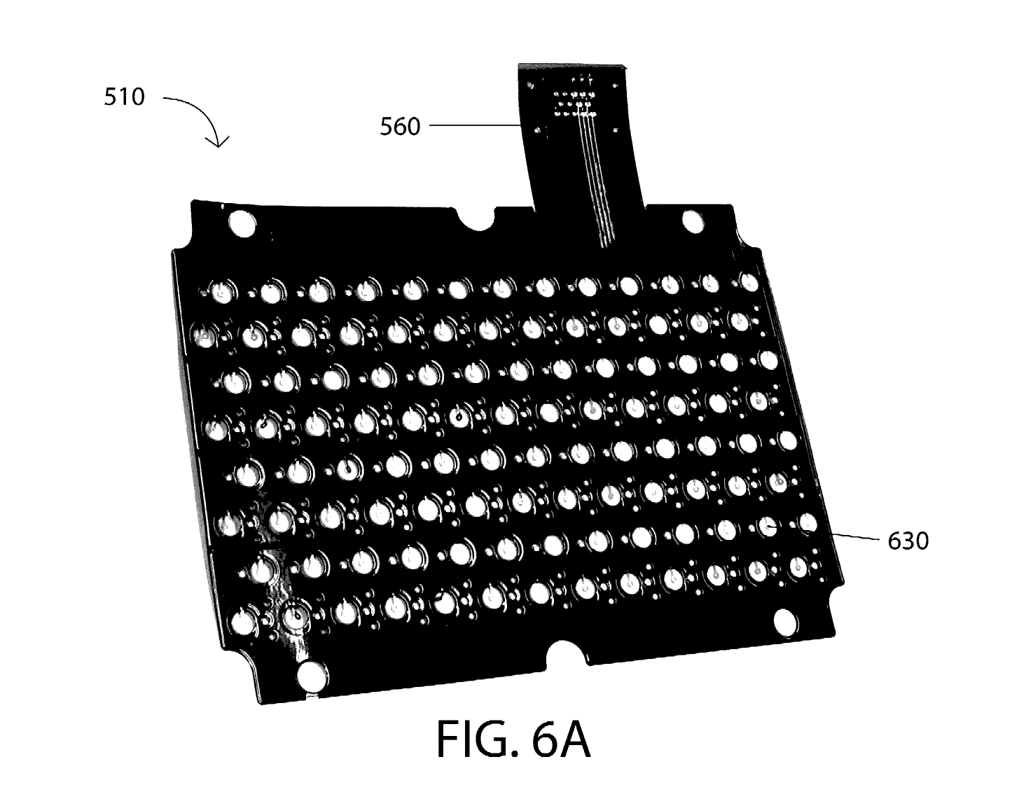

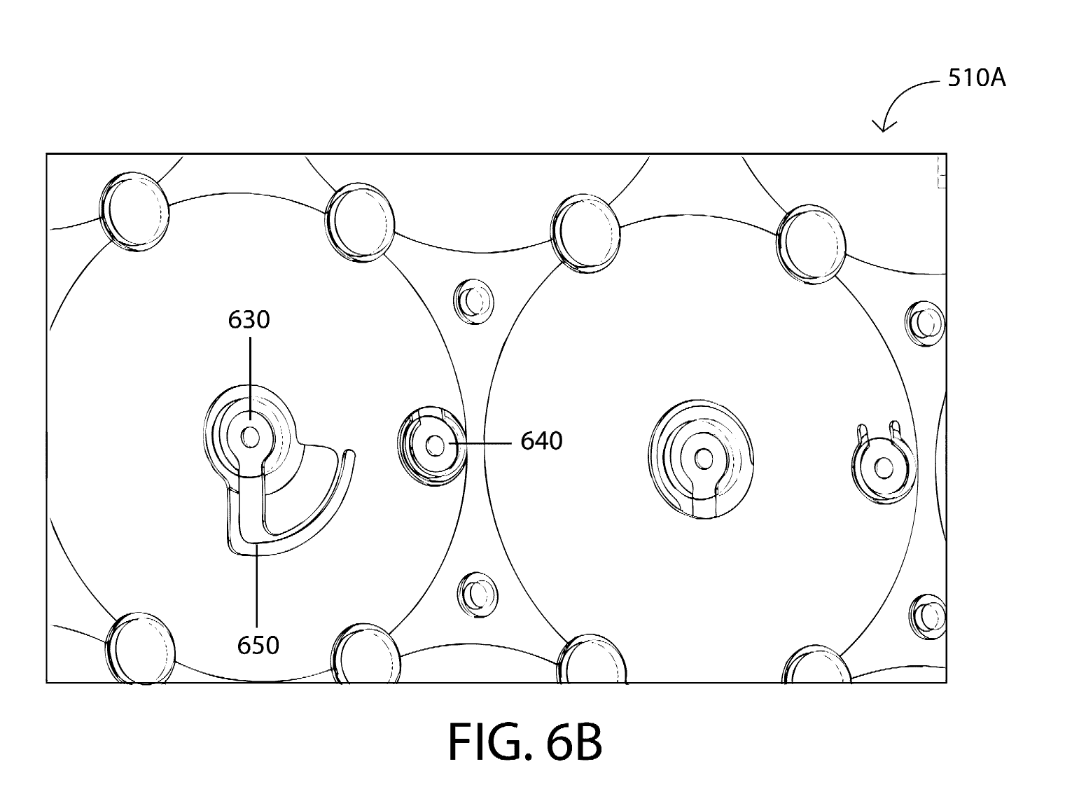

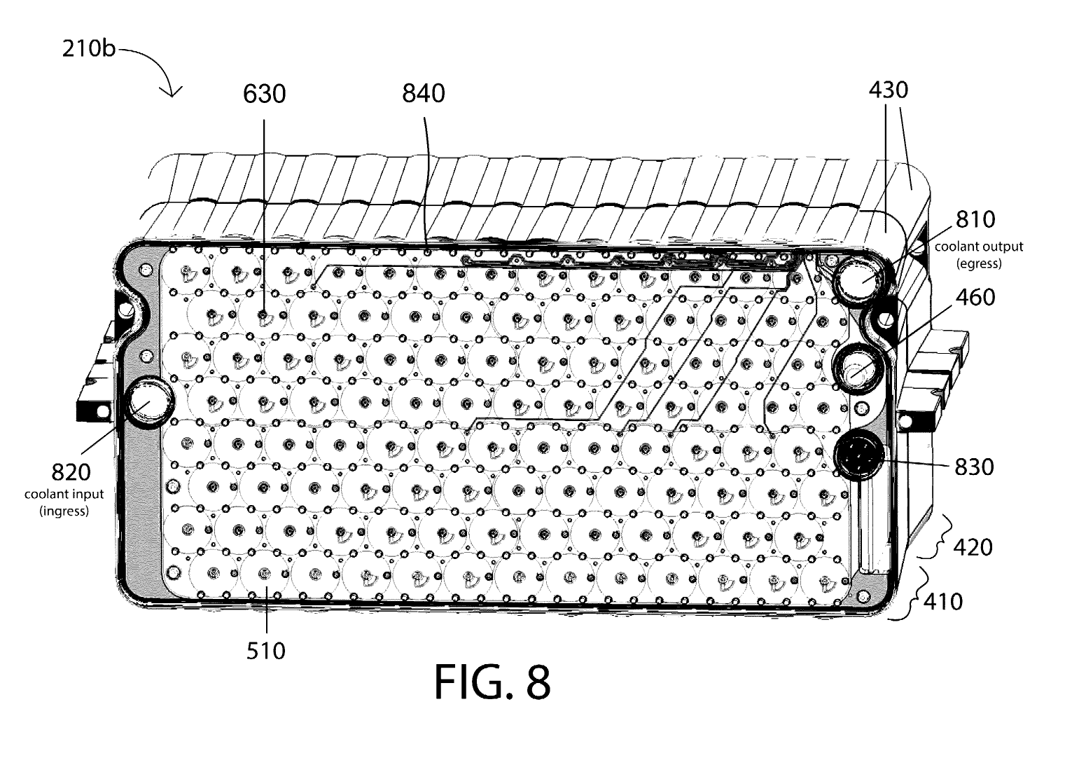

FIG. 4 includes a view 440 of enclosure 430 (e.g., with a cover removed). For each of half modules 410, 420 there is shown a plurality of battery cells 450 oriented (mounted) horizontally (see also FIG. 5 and FIG. 8). By way of non-limiting example, each half module includes one hundred four of battery cells 450. By way of further non-limiting example, eight of battery cells 450 are electrically connected in a series (e.g., the staggered column of eight battery cells 450 shown in FIG. 4), with a total of thirteen of such groups of eight battery cells 450 electrically connected in series. By way of additional non-limiting example, the thirteen groups (e.g., staggered columns of eight battery cells 450 electrically coupled in series) are electrically connected in parallel. This example configuration may be referred to as “8S13P” (8 series, 13 parallel). In some embodiments, the 8S13P electrical connectivity can be provided by current carrier 510, described further below in relation to FIGS. 5 and 6. Other combinations and permutations of battery cells 450 electrically coupled in series and/or parallel maybe used.

FIG. 5 depicts a view of half modules 410, 420 without enclosure 430 in accordance with various embodiments. Half modules 410 and 420 need not be the same, e.g., they may be mirror images of each other in some embodiments. Half modules 410 and 420 can include a plurality of battery cells 450. The plurality of battery cells 450 can be disposed between current carrier 510 and blast plate 520 such that an exterior side of each of battery cells 450 is not in contact with the exterior sides of other (e.g., adjacent) battery cells 450. In this way, coolant can circulate among and between battery cells 450 to provide submerged, evenly distributed cooling. In addition, to save the weight associated with coolant in areas where cooling is not needed, air pockets can be formed using channels craftily designed in the space 530 between current carrier 510 and blast plate 520 not occupied by battery cells 450. Coolant can enter half modules 410, 420 through coolant intake 540, is optionally directed by one or more flow channels, circulates among and between the plurality of battery cells 450, and exits through coolant outtake 550. In some embodiments, coolant intake 540 and coolant outtake 550 can each be male or female fluid fittings. In some embodiments, coolant or cooling fluid is at least one of: synthetic oil, water and ethylene glycol (WEG), poly-alpha-olefin (or poly-α-olefin, also abbreviated as PAO) oil, liquid dielectric cooling based on phase change, and the like. By way of further non-limiting example, the coolant may be at least one of: perfluorohexane (Flutec PP1), perfluoromethylcyclohexane (Flutec PP2), Perfluoro-1,3-dimethylcyclohexane (Flutec PP3), perfluorodecalin (Flutec PP6), perfluoromethyldecalin (Flutec PP9), trichlorofluoromethane (Freon 11), trichlorotrifluoroethane (Freon 113), methanol (methyl alcohol 283-403K), ethanol (ethyl alcohol 273-403K), and the like. Compared to techniques using metal tubes to circulate coolant, submerged cooling improves a packing density of battery cells 450 (e.g., inside battery module 210 and half modules 410, 420) by 15%, in various embodiments.

FIGS. 6A and 6B depict current carrier 510, 510A according to various embodiments. Current carrier 510, 510A is generally flat (or planar) and comprises one or more layers (not shown in FIGS. 6A and 6B), such as a base layer, a positive power plane, a negative power plane, and signal plane sandwiched in-between dielectric isolation layers (e.g., made of polyimide). In some embodiments, the signal plane can include signal traces and be used to provide battery module telemetry (e.g., battery cell voltage, current, state of charge, and temperature from optional sensors on current carrier 510) to outside of battery module 210.

As depicted in FIG. 6B, current carrier 510A can be a magnified view of a portion of current carrier 510, for illustrative purposes. Current carrier 510A can be communicatively coupled to each of battery cells 450, for example, at a separate (fused) positive (+) portion 630 and a separate negative (−) portion 640 which may be electrically coupled to the positive power plane and negative power plane (respectively) of current carrier 510A, and to each cathode and anode (respectively) of a battery cell 450. In some embodiments, positive (+) portion 630 can be laser welded to a cathode terminal of battery cell 450, and negative (−) portion 640 can be laser welded to an anode terminal of battery cell 450. In some embodiments, the laser-welded connection can have on the order of 5 milli-Ohms resistance. In contrast, electrically coupling the elements using ultrasonic bonding of aluminum bond wires can have on the order of 10 milli-Ohms resistance. Laser welding advantageously can have lower resistance for greater power efficiency and take less time to perform than ultrasonic wire bonding, which can contribute to greater performance and manufacturing efficiency.

Current carrier 510A can include a fuse 650 formed from part of a metal layer (e.g., copper, aluminum, etc.) of current carrier 510A, such as in the positive power plane. In some embodiments, the fuse 650 can be formed (e.g., laser etched) in a metal layer (e.g., positive power plane) to dimensions corresponding to a type of low-resistance resistor and acts as a sacrificial device to provide overcurrent protection. For example, in the event of thermal runaway of one of battery cell 450 (e.g., due to an internal short circuit), the fuse may “blow,” breaking the electrical connection to the battery cell 450 and electrically isolating the battery cell 450 from current carrier 510A. Although an example of a fuse formed in the positive power plane is provided, a fuse may additionally or alternatively be a part of the negative power plane.

Additional thermal runaway control can be provided in various embodiments by scoring on end 740 (identified in FIG. 7) of the battery cell 450. The scoring can promote rupturing to effect venting in the event of over pressure. In various embodiments, all battery cells 450 may be oriented to allow venting into the blast plate 520 for both half modules.

In some embodiments, current carrier 510 can be comprised of a printed circuit board and a flexible printed circuit. For example, the printed circuit board may variously comprise at least one of copper, FR-2 (phenolic cotton paper), FR-3 (cotton paper and epoxy), FR-4 (woven glass and epoxy), FR-5 (woven glass and epoxy), FR-6 (matte glass and polyester), G-10 (woven glass and epoxy), CEM-1 (cotton paper and epoxy), CEM-2 (cotton paper and epoxy), CEM-3 (non-woven glass and epoxy), CEM-4 (woven glass and epoxy), and CEM-5 (woven glass and polyester). By way of further non-limiting example, the flexible printed circuit may comprise at least one of copper foil and a flexible polymer film, such as polyester (PET), polyimide (PI), polyethylene naphthalate (PEN), polyetherimide (PEI), along with various fluoropolymers (FEP), and copolymers.

In addition to electrically coupling battery cells 450 to each other (e.g., in series and/or parallel), current carrier 510 can provide electrical connectivity to outside of battery module 210, for example, through main power connector 460 (FIG. 4). Current carrier 510 may also include electrical interface 560 (FIGS. 5, 6A) which transports signals from the signal plane. Electrical interface 560 can include an electrical connector (not shown in FIGS. 5, 6A).

FIG. 7 shows battery cell 450 according to some embodiments. In some embodiments, battery cell 450 can be a lithium ion (li-ion) battery. For example, battery cell 450 may be an 18650 type li-ion battery having a cylindrical shape with an approximate diameter of 18.6 mm and approximate length of 65.2 mm. Other rechargeable battery form factors and chemistries can additionally or alternatively be used. In various embodiments, battery cell 450 may include can 720 (e.g., the cylindrical body), anode terminal 770, and cathode terminal 780. For example, anode terminal 770 can be a negative terminal of battery cell 450 and cathode terminal 780 can be a positive terminal of battery cell 450. Anode terminal 770 and cathode terminal 780 can be electrically isolated from each other by an insulator or dielectric.

FIG. 8 illustrates another example of a battery module, battery module 210b, according to various embodiments. As described in relation to battery module 210 in FIG. 4, battery module 210b may include two half modules 410 and 420 and main power connector 460. Each of half modules 410 and 420 may include one of enclosure 430 for housing battery cells therein. Battery module 210b further depicts main coolant input port 820, main coolant output port 810, and communications and low power connector 830. Coolant can be provided to battery module 210b at main coolant input port 820, circulated within battery module 210b, and received at main coolant output port 810.

In contrast to the view of battery module 210 in FIG. 4, FIG. 8 depicts current carrier 510. Battery module 210b may include one or more staking features 840 to hold current carrier 510 in battery module 210b. For example, staking feature 840 can be a plastic stake. In some embodiments, communications and low power connector 830 can be at least partially electrically coupled to the signal plane and/or electrical interface 560 of current carrier 510, for example, through electronics for data acquisition and/or control (not shown in FIG. 8). Communications and low power connector 830 may provide low power, for example, to electronics for data acquisition and/or control, and sensors.

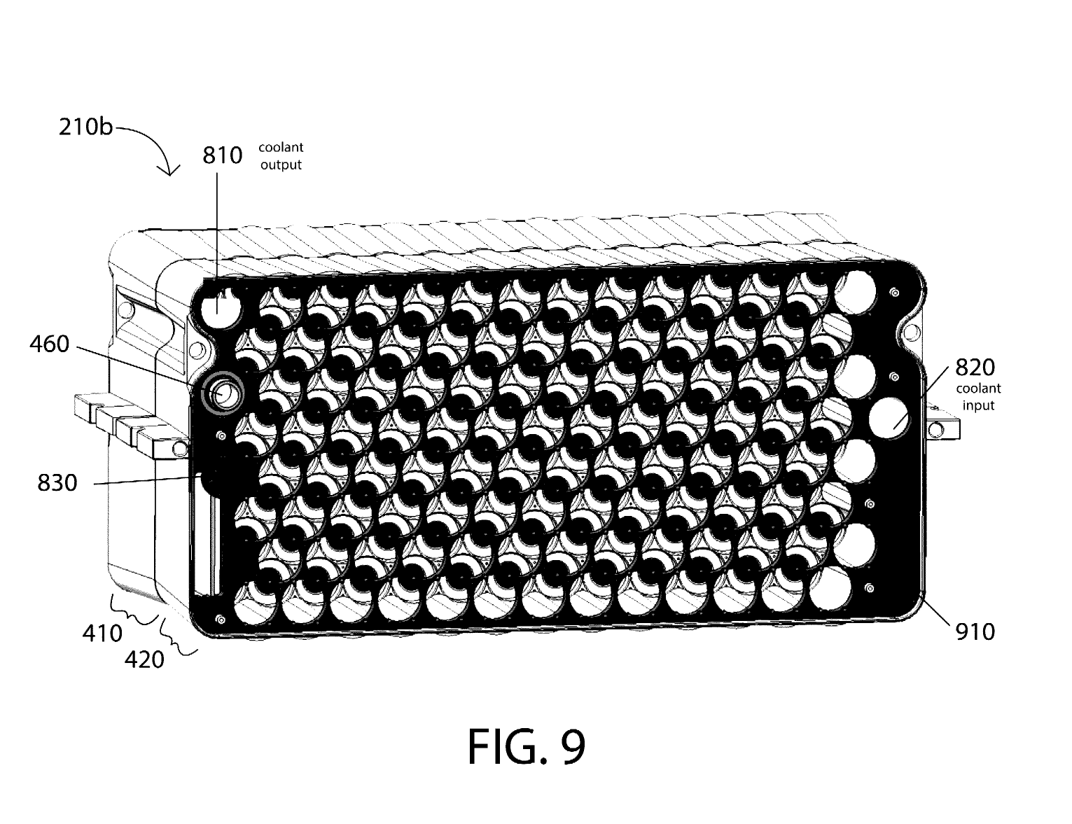

FIG. 9 shows another view of battery module 210b where the battery cells and the current carrier are removed from one of the half modules, for illustrative purposes. As described in relation to FIGS. 4 and 8, battery module 210b may include two half modules 410 and 420, main power connector 460, main coolant output port 810, main coolant input port 820, and communications and low power connector 830. Each of the half modules 410 and 420 can include an enclosure 430. Each enclosure 430 may further include plate 910 (e.g., a bracket). Plate 910 may include structures for securing the battery cells within enclosure 430 and maintaining the distance between battery cells.

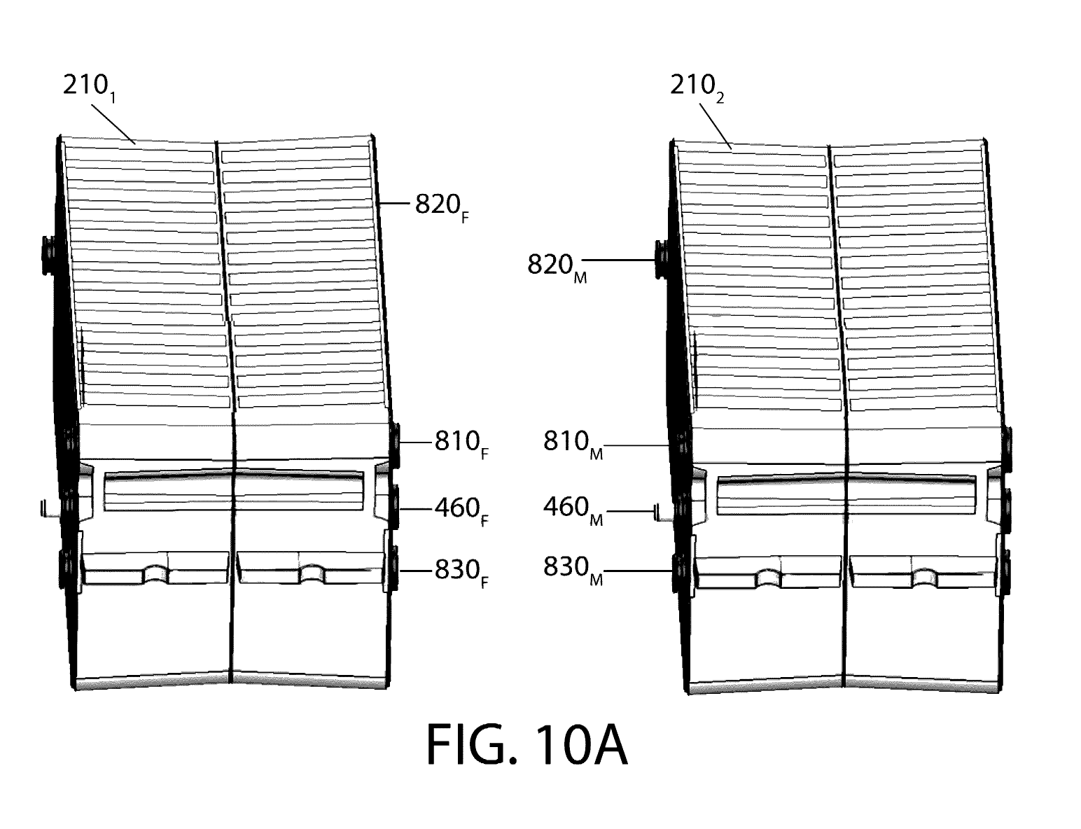

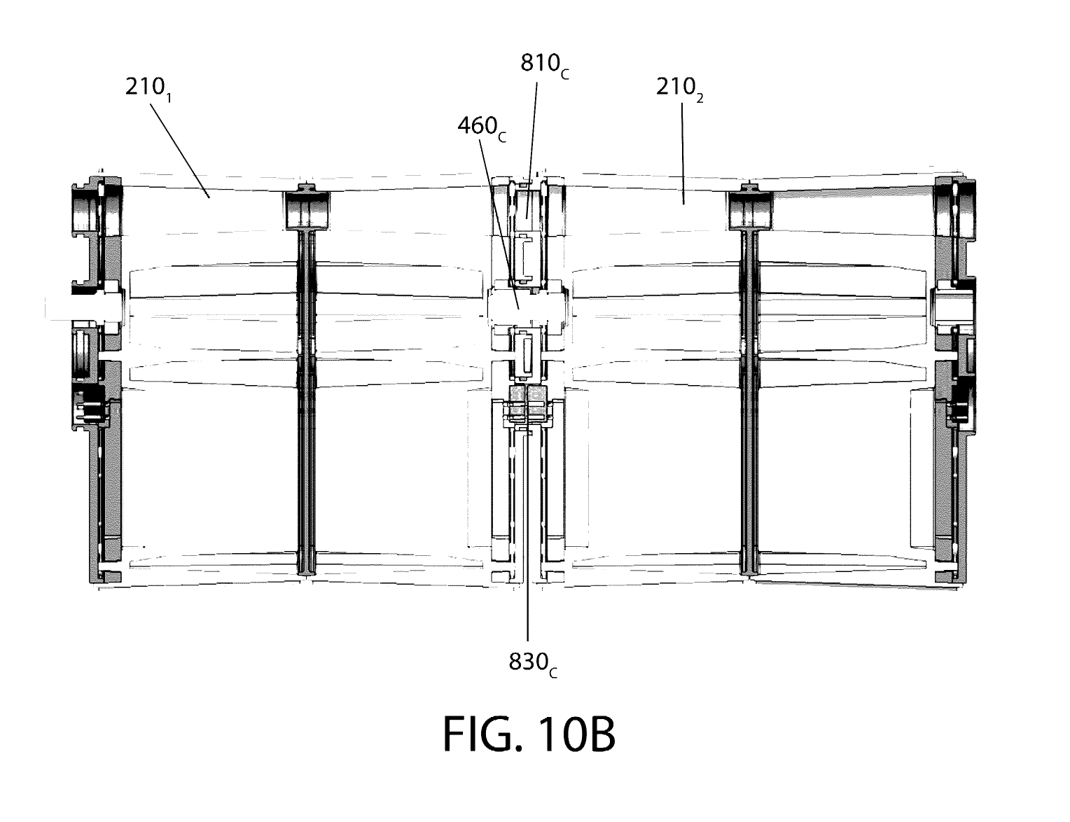

FIGS. 10A and 10B illustrate arrangement and coupling between two of battery modules 210b: 210₁ and 210₂. From different perspective views, FIG. 10A depicts battery modules 210₁ and 210₂ being apart and aligned for coupling. For example, battery modules 210₁ and 210₂ are positioned as shown in FIG. 10A and moved together until coupled as shown in the example in FIG. 10B. Generally, a female receptacle on one of battery modules 210₁ and 210₂ may receive and hold a male connector on the other of battery modules 210₂ and 210₁, respectively.

As shown in the example in FIG. 10A, a left side of battery modules 210₁ and 210₂ may have male connectors and a right side of battery modules 210₁ and 210₂ have female connectors, according to some embodiments. For example, the left sides of battery modules 210₁ and 210₂ include male main power connector 460_{M}, male main coolant output port 810_{M}, male main coolant input port 820_{M}, and male communications and low power connector 830_{M}. By way of further non-limiting example, the right sides of battery modules 210₁ and 210₂ can include female main power connector 460_{F}, female main coolant output port 810_{F}, female main coolant input port 820_{F}, and female communications and low power connector 830_{F}. Each of female main power connector 460_{F}, female main coolant output port 810_{F}, female main coolant input port 820_{F}, and female communications and low power connector 830_{F} may include an (elastomer) o-ring or other seal. Other combinations and permutations of male and female connectors—such as a mix of male and female connectors on each side, and female connectors on the right side and male connectors on the left side—may be used.

FIG. 10B depicts a cross-sectional view of battery modules 210₁ and 210₂ of FIG. 10A coupled together. For example, male main power connector 460_{M} and female main power connector 460_{F} (FIG. 10A) can combine to form coupled main power connectors 460_{C}, male main coolant output port 810_{M} and female main coolant output port 810_{F} can combine to form coupled main coolant output ports 810_{C}, male main coolant input port 820_{M} and female main coolant input port 820_{F} can combine to form coupled main coolant input ports 820_{C} (not shown in FIG. 10B), and female communications and low power connector 830_{F} and male communications and low power connector 830_{M} can combine to form coupled communications and low power connectors 830_{C}. As a result, the internal cooling channels or manifolds of the battery modules can be connected through the coupling between the modules, forming the cooling system schematically illustrated in FIG. 3.

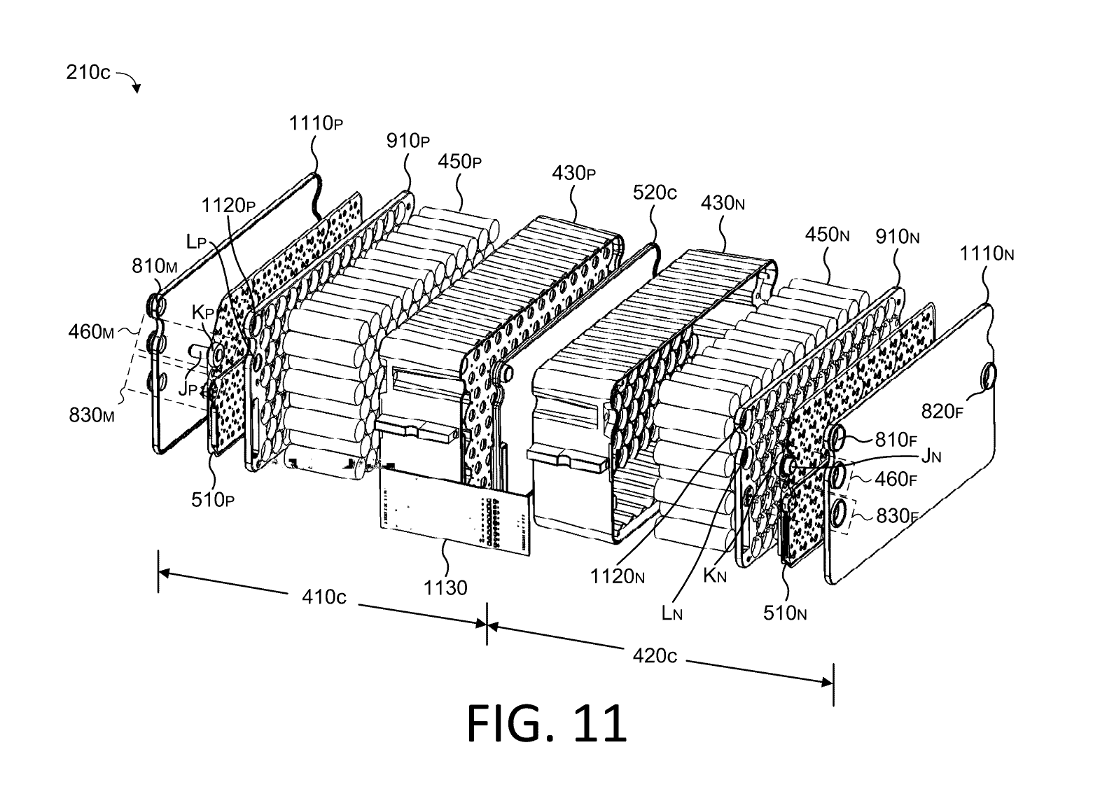

FIG. 11 shows an exploded view of battery module 210_{C} according to some embodiments. As described in relation to battery module 210 in FIGS. 4 and 210b in FIG. 8, battery module 210_{C} can include two half modules 410_{C} and 420_{C}. Half modules 410_{C} and 420_{C} can be coupled together as was described in relation to FIG. 10B.

Half module 410_{C} can be a three-dimensional mirror image of half module 420_{C}, and vice-versa. Half modules 410_{C} and 420_{C} can each include half shell 430_{P} and 430_{N}, battery cells 450_{P} and 450_{N}, cell retainer 910_{P} and 910_{N}, flexible circuit 510_{P} and 510_{N}, and module cover 1110_{P} and 1110_{N}, respectively. Half shells 430_{P} and 430_{N} were described in relation to enclosures 430 in FIGS. 4, 8, and 9. Battery cells 450_{P} and 450_{N} were described in relation to battery cells 450 in FIGS. 4, 5, and 7. Cell retainers 910_{P} and 910_{N} were described in relation to plate 910 in FIG. 9. Flexible circuits 510_{P} and 510_{N} were described in relation to current carrier 910 in FIG. 9. Center divider 520_{C} was described in relation to blast plate 520 in FIG. 5.

In some embodiments, battery module 210_{C} can include telemetry module 1130. Telemetry module 1130 was described above in relation to electronics for data acquisition and/or control, and sensors (FIG. 8). Telemetry module 1130 can be communicatively coupled to flexible circuit 510_{P} and/or 510_{N}. Additionally or alternatively, telemetry module 1130 can be communicatively coupled to male communications and low power connector 830_{M} and/or female communications and low power connector 830_{F}.

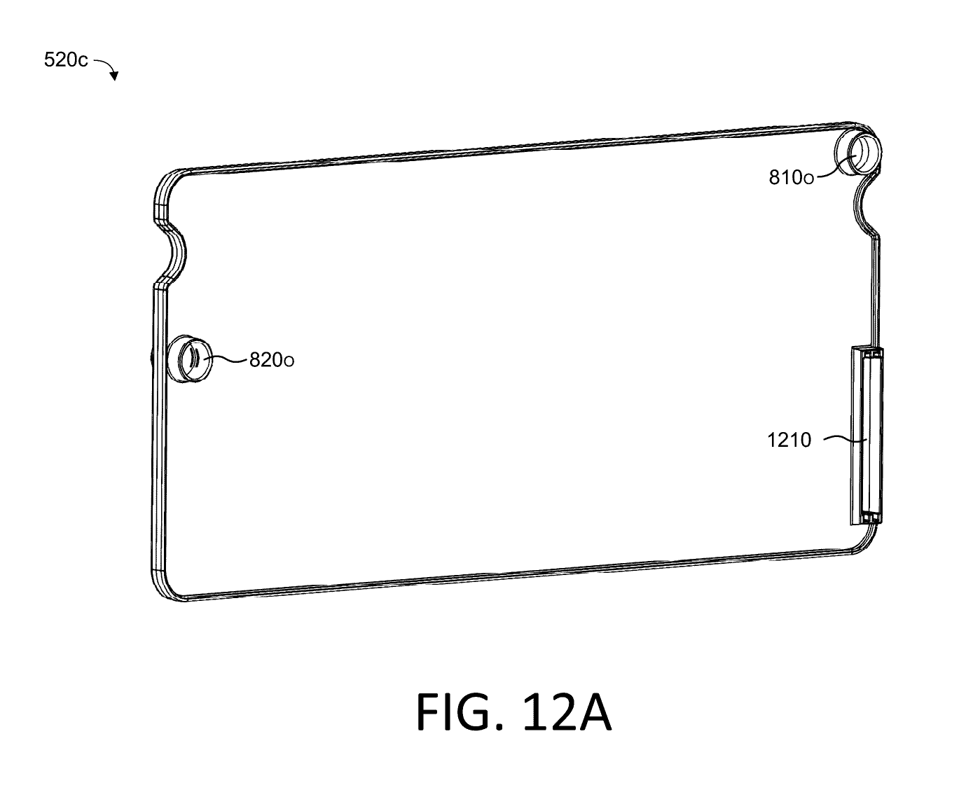

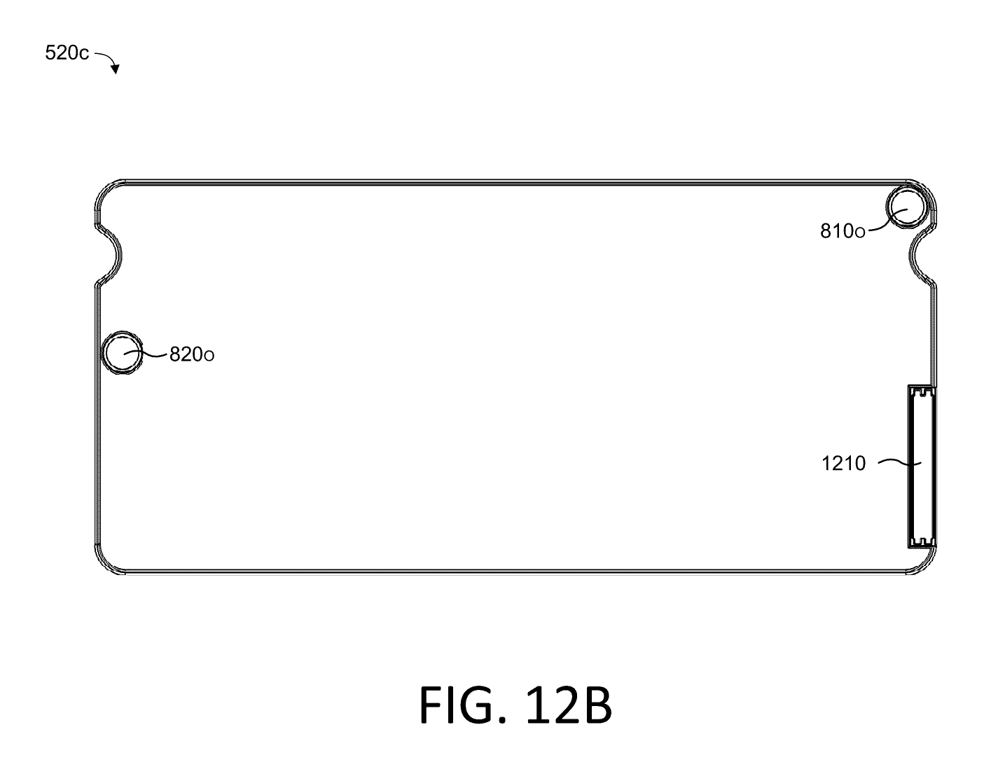

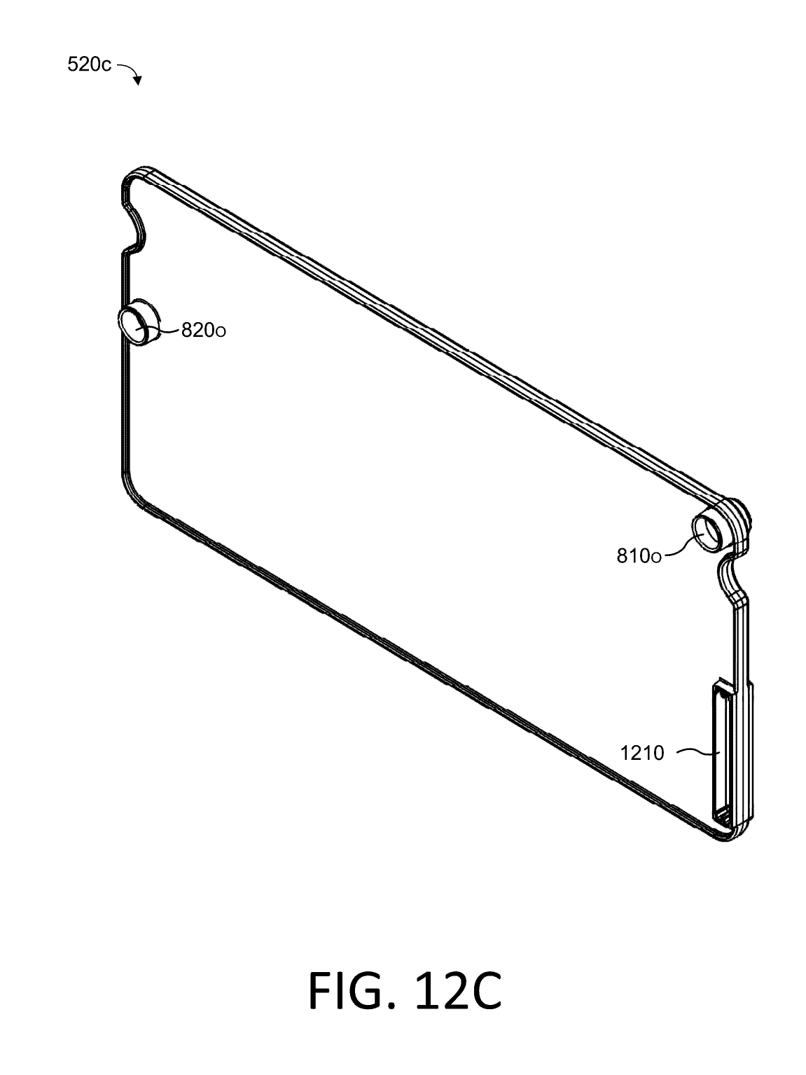

FIGS. 12A-C depict assorted views of center divider 520_{C}. Center divider 520_{C} can include opening 810_{O} for coolant flow associated with main coolant output port 810 (FIG. 8) and/or opening 820_{O} for coolant flow associated with main coolant input port 820. Center divider 520_{C} can include opening 1210 which may be occupied by a section of telemetry module 1130. Center divider 520_{C} can comprise at least one of polycarbonate, polypropylene, acrylic, nylon, and acrylonitrile butadiene styrene (ABS). In exemplary embodiments, center divider 520_{C} can comprise one or more materials having low electrical conductivity or high electrical resistance, such as a dielectric constant or relative permittivity (e.g., ε or κ) less than 15 and/or a volume resistance greater than 10¹⁰ ohm·cm, and/or low thermal conductivity (e.g., less than 1 W/m·° K).

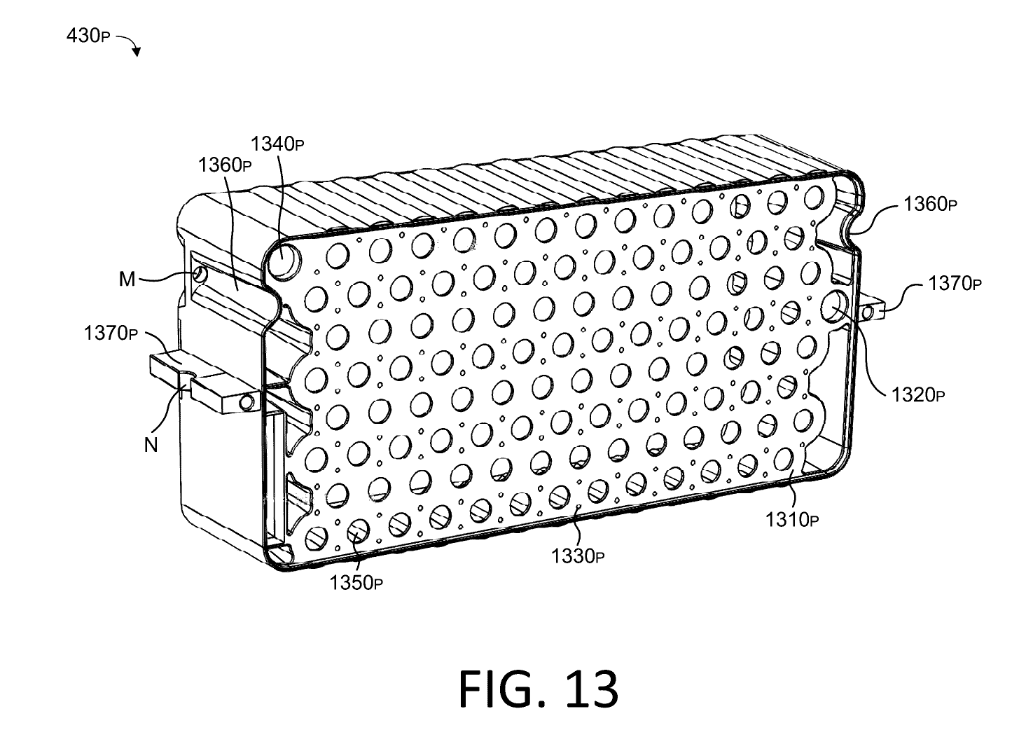

FIG. 13 shows half shell 430_{P} according to some embodiments. Half shell 430_{P} (and 430_{N} shown in FIG. 11) can comprise at least one of polycarbonate, polypropylene, acrylic, nylon, and ABS. In exemplary embodiments, half shell 430_{P} (and 430_{N}) can comprise one or more materials having low electrical conductivity or high electrical resistance, such as a dielectric constant or relative permittivity (e.g., ε or κ) less than 15 and/or a volume resistance greater than 10¹⁰ ohm·cm, and/or low thermal conductivity (e.g., less than 1 W/m·° K).

Half shell 430_{P} can include base 1310_{P}. In some embodiments, base 1310_{P} and the rest of half shell 430_{P} can be formed from a single mold. Base 1310_{P} can include channel 1340_{P} formed in half shell 430_{P} for coolant flow associated with main coolant output port 810 (FIG. 8) and/or channel 1320_{P} formed in half shell 430_{P} coolant flow associated with main coolant input port 820. Base 1310_{P} can include (small) holes 1330_{P}. For example, the size and/or placement of holes 1330_{P} in base 1310_{P} can be optimized using computational fluid dynamics (CFD), such that each of holes 1330_{P} experiences the same inlet pressure (e.g., in a range of 0.05 pounds per square inch (psi)—5 psi), flow distribution of coolant through holes 1330_{P} is even, and the same volume flow (e.g., ±0.5 L/min in a range of 0.05 L/min-5 L/min) is maintained through each of holes 1330_{P}. For example, holes 1330_{P} may each have substantially the same diameter (e.g., ±1 mm in a range of 0.5 mm to 5 mm). Such optimized size and/or placement of holes 1330_{P} in base 1310_{P} can contribute to even cooling of batteries 450_{P}, since each of batteries 450_{P} experiences substantially the same volume flow of coolant.

In some embodiments, base 1310_{P} may contribute to retention of batteries 450_{P} in half module 410_{C}. Base 1310_{P} can include battery holes 1350 _{P} about which batteries 450_{P} are disposed (e.g., end 740 (FIG. 7) of one of battery cell 450 is positioned centered about one of battery holes 1350_{P}). For example, at least some of batteries 450_{P} can be fixedly attached to base 1310_{P} using, for example, ultraviolet (UV) light curing adhesives, also known as light curing materials (LCM). Light curing adhesives can advantageously cure in as little as a second and many formulations can advantageously bond dissimilar materials and withstand harsh temperatures. Other adhesives can be used, such as synthetic thermosetting adhesives (e.g., epoxy, polyurethane, cyanoacrylate, and acrylic polymers).

Half shell 430_{P} can also include tabs 1370_{P} and gusset 1360_{P}. Half shell 430_{N} (FIG. 11) can be a three-dimensional mirror image of half shell 430_{P}. For example, half shell 430_{N} can include a base having a channel for coolant flow associated with main coolant output port 810 (FIG. 8) and/or a channel for coolant flow associated with main coolant input port 820, (small) holes, battery holes, tabs, and gusset that are three-dimensional mirror images of their respective half shell 430_{P} counterparts (e.g., base 1310_{P}, channel 1340_{P} for coolant flow associated with main coolant output port 810 (FIG. 8), channel 1320_{P} for coolant flow associated with main coolant input port 820, (small) holes 1330_{P}, battery holes 1350_{P}, tabs 1370_{P}, and gusset 1360_{P}, respectively).

Gussets 1360_{P} and the corresponding gussets on half shell 430_{N} can include holes M. In some embodiments a portion of a tie rod (not shown in FIG. 13) can be in (occupy) gusset 1360_{P} and the corresponding gusset on half shell 430_{N}, and pass through each hole M of half modules 410_{C} and 420_{C}. For example, half modules 410_{C} and 420_{C} can each have two gussets on opposite sides of half shell 430_{P} and 430_{N} (respectively) and two tie rods, such that the two tie rods each go through two locations on a battery module 210_{C}, providing four points of (secondary) retention. The rods can also hold two or more of battery modules 210 together when combined into string 212 (FIG. 2A), for retention and handling/moving.

Tabs 1370_{P} and the corresponding tabs on half shell 430_{N} can include cut out section N. Tabs 1370_{P} and the corresponding tabs on half shell 430_{N} can be used to laterally support two or more of battery modules 210_{C} coupled together, for example, as in string 212 (FIG. 2A) installed in enclosure 200 (FIG. 2B). For example, a retention plate (not shown in FIG. 13) may be placed over tabs 1370_{P} and the corresponding tabs on half shell 430_{N}. A fastener (not depicted in FIG. 13) may affix the retention plate to a lateral extrusion 270 (FIG. 2B) in enclosure 200. The fastener can pass through cut out section N.

Referring back to FIG. 11, cell retainers 910_{P} and 910_{N} can contribute to structural support of batteries 450_{P} and 450_{N}, respectively. For example, cell retainers 910_{P} and 910_{N} can keep or hold batteries 450_{P} and 450_{N} (respectively) in place. In some embodiments, at least some of batteries 450_{P} and 450_{N} can be fixedly attached to cell retainers 910_{P} and 910_{N} (respectively) using, for example, ultraviolet (UV) light curing adhesives or other adhesives, as described above in relation to FIG. 13. Cell retainers 910_{P} and 910_{N} can comprise at least one of polycarbonate, polypropylene, acrylic, and nylon, and ABS. In exemplary embodiments, cell retainers 910_{P} and 910_{N} can comprise one or more materials having low electrical conductivity or high electrical resistance, such as a dielectric constant or relative permittivity (e.g., ε or κ) less than 15 and/or a volume resistance greater than 10¹⁰ ohm·cm, and/or low thermal conductivity (e.g., less than 1 W/m·° K). Cell retainers 910_{P} and 910_{N} can also contribute to structural support of flexible circuit 510_{P} and 510_{N}, respectively. For example, cell retainers 910_{P} and 910_{N} can hold flexible circuit 510_{P} and 510_{N}, respectively.

Flexible circuit 510_{P} can include power bud J_{P} and flexible circuit 510_{N} can include power socket J_{N}. Power bud J_{P} and power socket J_{N} were described in relation to main power connector 460 (FIG. 4). Power bud J_{P} can be brazed onto flexible circuit 510_{P} and power socket J_{N} can be brazed onto flexible circuit 510_{N}. Power bud J_{P} and power socket J_{N} can comprise any conductor, such as aluminum (alloy) and/or copper (alloy). Power bud J_{P} and power socket J_{N} can include conductive ring K_{P} and K_{N}, respectively. Conductive ring K_{P} and K_{N} can be placed into (attached to) hole L_{P} and L_{N} (respectively) of cell retainer 910_{P} and 910_{N}, respectively. In this way, conductive ring K_{P} and K_{N} can provide a larger surface area for attaching flexible circuit 510_{P} and 510_{N} (respectively) to cell retainer 910_{P} and 910_{N}, respectively. Conductive ring K_{P} and K_{N} can comprise any conductor, such as aluminum (alloy) and copper (alloy). In some embodiments, conductive ring K_{P} and K_{N} can comprise the same material as power bud J_{P} and power socket J_{N}, respectively.

Module cover 1110_{P} can include male main power connector 460_{M}, male main coolant output port 810_{M}, male main coolant input port 820_{M} (not shown in FIG. 11), and male communications and low power connector 830_{M}. Module cover 1110_{N} can include female main power connector 460_{F}, female main coolant output port 810_{F}, female main coolant input port 820_{F}, and female communications and low power connector 830_{F}. Male main power connector 460_{M}, female main power connector 460_{F}, male main coolant output port 810_{M}, female main coolant output port 810_{F}, male main coolant input port 820_{M}, female main coolant input port 820_{F}, male communications and low power connector 830_{M}, female communications and low power connector 830_{F} were described in relation to FIG. 10A. In various embodiments, half module 410_{C} is a “positive” end of battery module 210_{C} and half module 420_{C} is a “negative” end of battery module 210_{C}.

Module covers 1110_{P} and 1110_{N} can comprise at least one of polycarbonate, polypropylene, acrylic, nylon, and ABS. In exemplary embodiments, module covers 1110_{P} and 1110_{N} can comprise one or more materials having low electrical conductivity or high electrical resistance, such as a dielectric constant or relative permittivity (e.g., ε or κ) less than 15 and/or a volume resistance greater than 10¹⁰ ohm·cm, and/or low thermal conductivity (e.g., less than 1 W/m·° K).

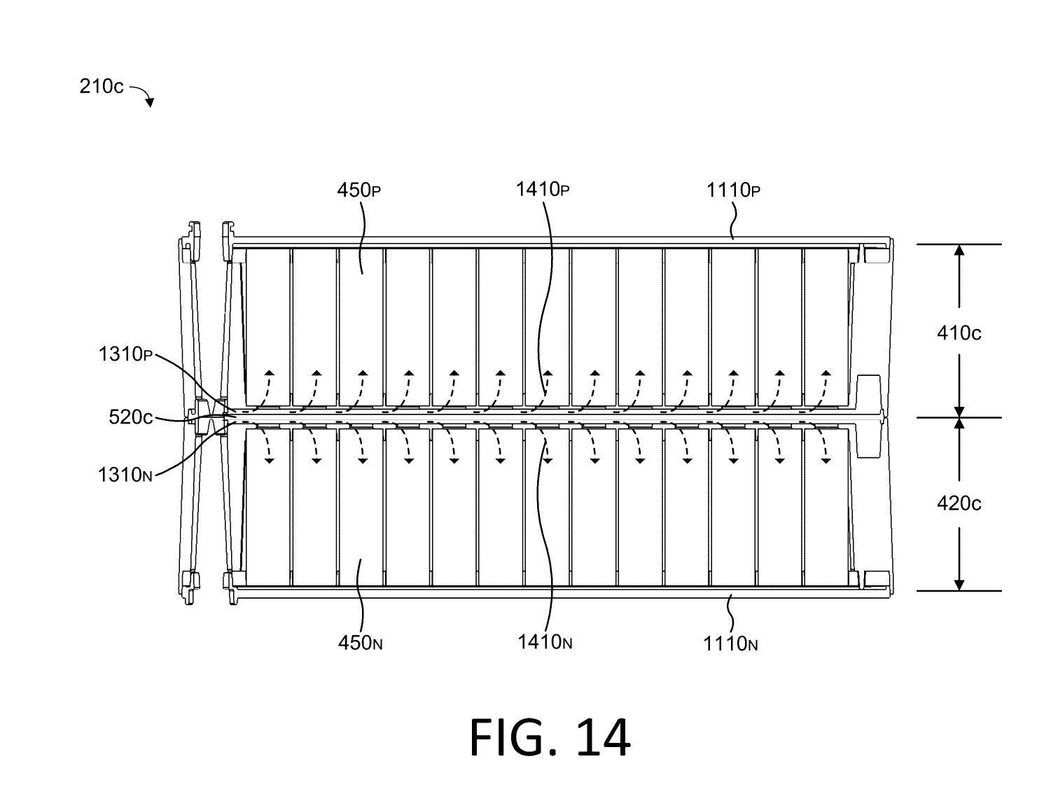

FIG. 14 illustrates a cross-sectional view of battery module 210_{C}. FIG. 14 depicts half modules 410_{C} and 420_{C} coupled to form battery module 210_{C}. Center divider 520_{C} can be disposed between half modules 410_{C} and 420_{C}. Half modules 410_{C} and 420_{C} can include base 1310_{P} and 1310_{N}, battery cells 450_{P} and 450_{N}, and module cover 1110_{P} and 1110_{N}, respectively.

Referring back to FIG. 11, in operation coolant can enter or flow into battery module 210_{C} at male main coolant input port 820_{M} (not depicted in FIG. 11, see FIG. 10A). For example, a pump (not shown in FIG. 11) can pump coolant through battery module 210_{C}, such that the coolant pressure is on the order of less than 5 pounds per square inch (psi), for example, about 0.7 psi. Coolant can travel through channel 1320_{P} (FIG. 13) to center divider 520_{C}, where the coolant (flow) can be divided between half modules 410_{C} and 420_{C} (e.g., such that there is a first coolant flow for half module 410_{C} (represented as dashed lines 1410_{P} in FIG. 14) and a second coolant flow for half module 420_{C} (represented as dashed lines 1410_{N} in FIG. 14)).

At base 1310_{P} (FIG. 13) and base 1310_{N} (not depicted in FIG. 13), the divided coolant flows through holes 1330_{P} and 1330_{N} (not depicted in FIG. 13) (respectively) and toward module covers 1110_{P} and 1110_{N}, respectively. In half module 410_{C}, toward module cover 1110_{P} coolant can enter channel 1340_{P}, flow through channel 1340_{N} (not depicted in FIG. 13) in half module 420_{C}, and exit battery module 210_{C} at female main coolant output port 810_{F}. In half module 420_{C}, toward module cover 1110_{N}, the coolant exits battery module 210_{C} at female main coolant output port 810_{F}. In various embodiments, channels 1320_{P}, 1340_{P}, 1320_{N} (not depicted in FIG. 13), and 1340_{N} are structured such that coolant flow is not “short circuited” (e.g., coolant flows from 1320_{P} to 1340_{P} and/or from 1320_{N} to 1340_{N} without passing through base 1310_{P} and/or 1310_{N} (respectively) to battery cells 450_{P} and 450_{N} (respectively)). By way of non-limiting example, center divider 520_{C} can be structured such that coolant (flow) is evenly divided between half modules 410_{C} and 420_{C}. By way of further non-limiting example, base 1310_{P} and/or base 1310_{N} can be structured (e.g., size and position of holes 1330_{P} and 1330_{N}) such that coolant flows evenly through holes 1330_{P} and 1330_{N}. In some embodiments, the first coolant flow flows over the battery cells in a first direction within half module 410_{C} (represented as dashed lines 1410_{P} in FIG. 14), and the second coolant flow flows over the battery cells in a second direction within half module 420_{C} (represented as dashed lines 1410_{N} in FIG. 14). The first direction and the second direction can be (substantially) the opposite of each other.

According to some embodiments, the coolant can comprise any non-conductive fluid that will inhibit ionic transfer and have a high heat or thermal capacity (e.g., at least 60 J/(mol K) at 90° C.). For example, the coolant can be at least one of: synthetic oil, water and ethylene glycol (WEG), poly-alpha-olefin (or poly-α-olefin, also abbreviated as PAO) oil, liquid dielectric cooling based on phase change, and the like. By way of further non-limiting example, the coolant may be at least one of: perfluorohexane (Flutec PP1), perfluoromethylcyclohexane (Flutec PP2), Perfluoro-1,3-dimethylcyclohexane (Flutec PP3), perfluorodecalin (Flutec PP6), perfluoromethyldecalin (Flutec PP9), trichlorofluoromethane (Freon 11), trichlorotrifluoroethane (Freon 113), methanol (methyl alcohol 283-403K), ethanol (ethyl alcohol 273-403K), and the like.

In various embodiments, half shell 430_{P} and 430_{N} can comprise an opaque (e.g., absorptive of laser light) material such as at least one of polycarbonate, polypropylene, acrylic, nylon, and ABS. In some embodiments, center divider 520_{C}, cell retainers 910_{P} and 910_{N}, and module covers 1110_{P} and 1110_{N} can each comprise a (different) transparent (e.g., transmissive of laser light) material such as polycarbonate, polypropylene, acrylic, nylon, and ABS. In exemplary embodiments, half shell 430_{P} and 430_{N}, center divider 520_{C}, cell retainers 910_{P} and 910_{N}, and module covers 1110_{P} and 1110_{N} all comprise the same material, advantageously simplifying a laser welding schedule.

Half shell 430_{P} and 430_{N} can be joined to center divider 520_{C}, cell retainers 910_{P} and 910_{N}, and module covers 1110_{P} and 1110_{N} using laser welding, where two of the parts are put under pressure while a laser beam moves along a joining line. The laser beam can pass through the transparent part and be absorbed by the opaque part to generate enough heat to soften the interface between the parts creating a permanent weld. Semiconductor diode lasers having wavelengths on the order of 808 nm to 980 nm and power levels from less than 1 W to 100 W can be used, depending on the materials, thickness, and desired process speed. Laser welding offers the advantages of being cleaner than adhesive bonding, having no micro-nozzles to get clogged, having no liquid or fumes to affect surface finish, having no consumables, having higher throughput than other bonding methods, providing access to pieces having challenging geometries, and having a high level of process control. Other welding methods, such as ultrasonic welding, can be used.

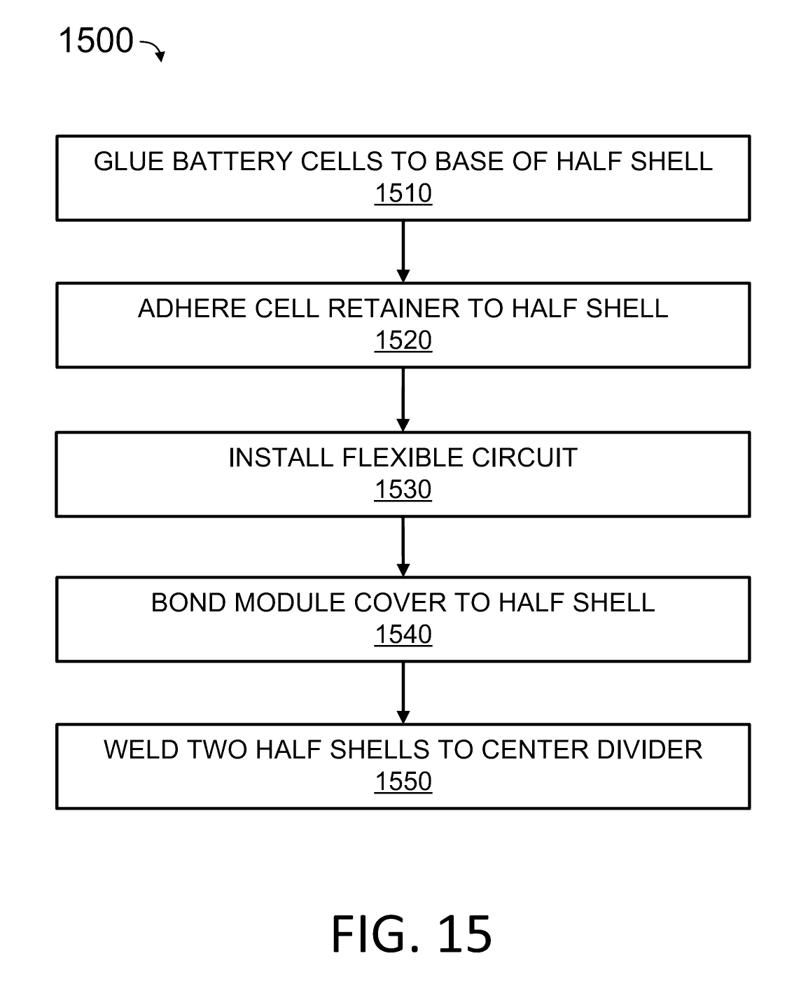

FIG. 15 depicts a simplified flow diagram for a process 1500 for assembling battery module 210_{C}. Although the steps comprising process 1500 are shown in a certain sequence, they may be performed in any order. Additionally, assorted combinations of the steps may be performed concurrently. In exemplary embodiments, process 1500 can produce hermetic seals at each of the fluid boundary areas of battery module 210_{C}: half shell 430_{P} and 430_{N}, center divider 520_{C}, and module covers 1110_{P} and 1110_{N}.

At step 1510, at least some of battery cells 450_{P} (and 450_{N}) can be fixedly attached to base 1310_{P} (and base 1310_{N} (not depicted in FIG. 13) of half shell 430_{N}), as described above in relation to FIG. 13. At step 1520, cell retainers 910_{P} and 910_{N} can be coupled to half shells 430_{P} and 430_{N}, respectively. For example, cell retainers 910_{P} and 910_{N} can be at least one of laser welded, ultrasonic welded, and glued (e.g., using one or more synthetic thermosetting adhesives) to half shells 430_{P} and 430_{N}, respectively.

At step 1530, flexible circuits 510_{P} and 510_{N} can be installed in half shells 430_{P} and 430_{N}, respectively. For example, flexible circuits 510_{P} and 510_{N} can be hot staked to cell retainers 910_{P} and 910_{N} and/or half shells 430_{P} and 430_{N}, respectively. At step 1540, module covers 1110_{P} and 1110_{N} can be bonded to half shells 430_{P} and 430_{N}, respectively. For example, module covers 1110_{P} and 1110_{N} can be at least one of laser welded, ultrasonic welded, and glued (e.g., using one or more synthetic thermosetting adhesives) to half shells 430_{P} and 430_{N}, respectively.

At step 1550, center divider 520_{C} can be attached to half shells 430_{P} and 430_{N}. For example, center divider 520_{C} can be at least one of laser welded, ultrasonic welded, and glued (e.g., using one or more synthetic thermosetting adhesives) to half shells 430_{P} and 430_{N}.

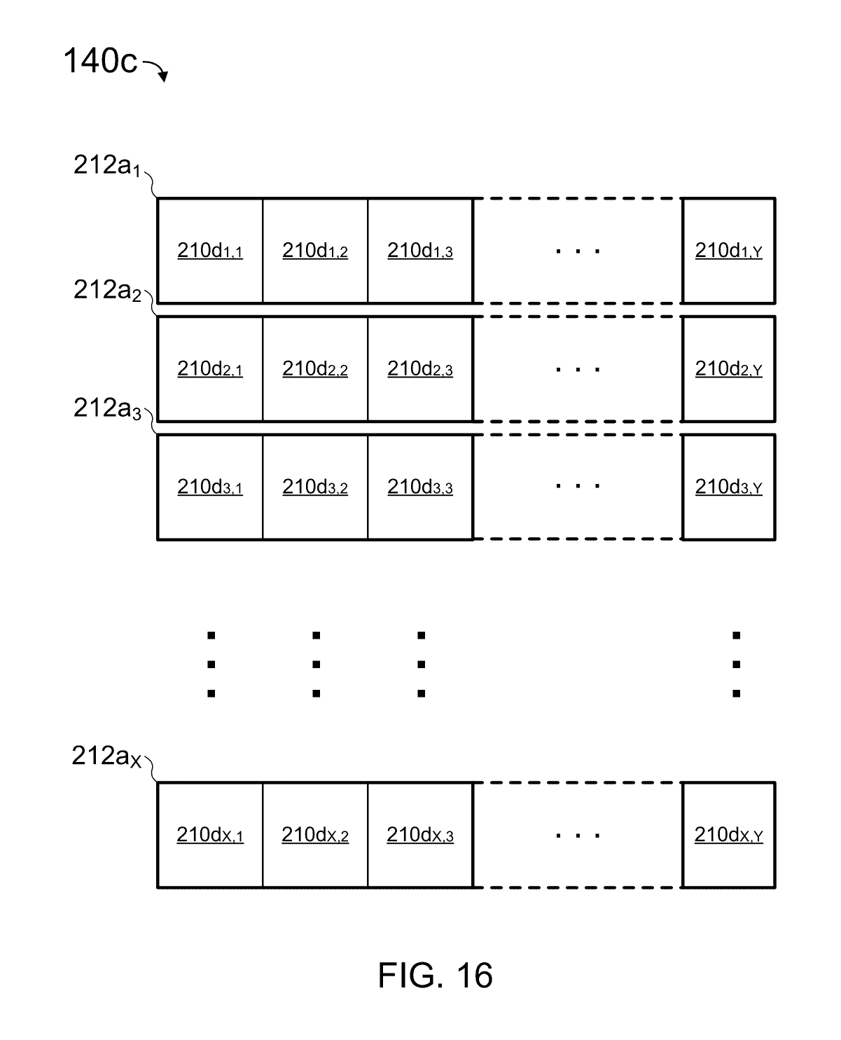

FIG. 16 illustrates battery pack 140_{C} in accordance with various embodiments. As described in relation to battery pack 140a in FIG. 1, battery pack 140_{C} may be disposed in and protected by electric car 100. Battery pack 140_{C} can additionally or alternatively include all or some of the features and characteristics of battery pack 140b in FIGS. 2A, 2B, and 3.

Battery pack 140_{C} may comprise any number of strings 212a (i.e., strings 212a₁-212aₓ). By way of non-limiting example, battery pack 140_{C} comprises six strings 212a₁-212aₓ (i.e., X=6), such that battery pack 140_{C} comprises strings 212a₁-212a₆. Strings 212a can each include all or some of the features and characteristics of string 212 described in reference to FIG. 2A. In exemplary embodiments, strings 212a in battery pack 140_{C} are electrically coupled in parallel.

Each of strings 212a (i.e., strings 212a₁₋₂₁₂aₓ) may comprise any number of battery modules 210d (i.e., battery modules 210d_{1,1}-210d_{x,y}). By way of non-limiting example, each of strings 212a include six battery modules 210d (i.e., of battery modules 210d_{1,1}-210d_{x,y}) (i.e., Y=6), such that string 212a₁ comprises battery modules 210d_{1,1}-210d_{1,6}; string 212a₂ comprises battery modules 210d_{2,1}-210d_{2,6}; string 212a₃ comprises battery modules 210d_{3,1}-210d_{3,6}; string 212a₄ comprises battery modules 210d_{4,1}-210d_{4,6}; string 212a₅ comprises battery modules 210d_{5,1}-210d_{5,6}; and string 212a₆ comprises battery modules 210d_{6,1}-210d_{6,6}.

In exemplary embodiments, battery modules 210d in each string 212a are electrically coupled in series. By way of further non-limiting example, battery modules 210d_{1,1}-210d_{1,6} in string 212a₁ are electrically coupled in series; battery modules 210d_{2,1}-210d_{2,6} in string 212a₂ are electrically coupled in series; battery modules 210d_{3,6}-210d_{3,6} in string 212a₃

are electrically coupled in series; battery modules 210d_{4,1}-210d_{4,6} in string 212a₄

are electrically coupled in series; battery modules 210d_{5,1}-210d_{5,6} in string 212a₅ are electrically coupled in series; and battery modules 210d_{6,1}-210d_{6,6} in string 212a₆ are electrically coupled in series.

Each of battery modules 210d can include all or some of the features and characteristics of battery module 210 described in relation to FIGS. 2A, 2B, 3, 4, 5, 6A, 6B, and 7; battery module 210b described in relation to FIGS. 8, 9, 10A, and 10B; and battery module 210c described in relation to FIGS. 11, 12A, 12B, 12C, 13, 14, and 15. For example, each of battery modules 210d includes battery cells (not shown in FIG. 16), such as battery cells 450 described with reference to FIGS. 4, 5, and, 7, and battery cells 450_{P} and 450_{N} described with reference to FIGS. 11 and 14.

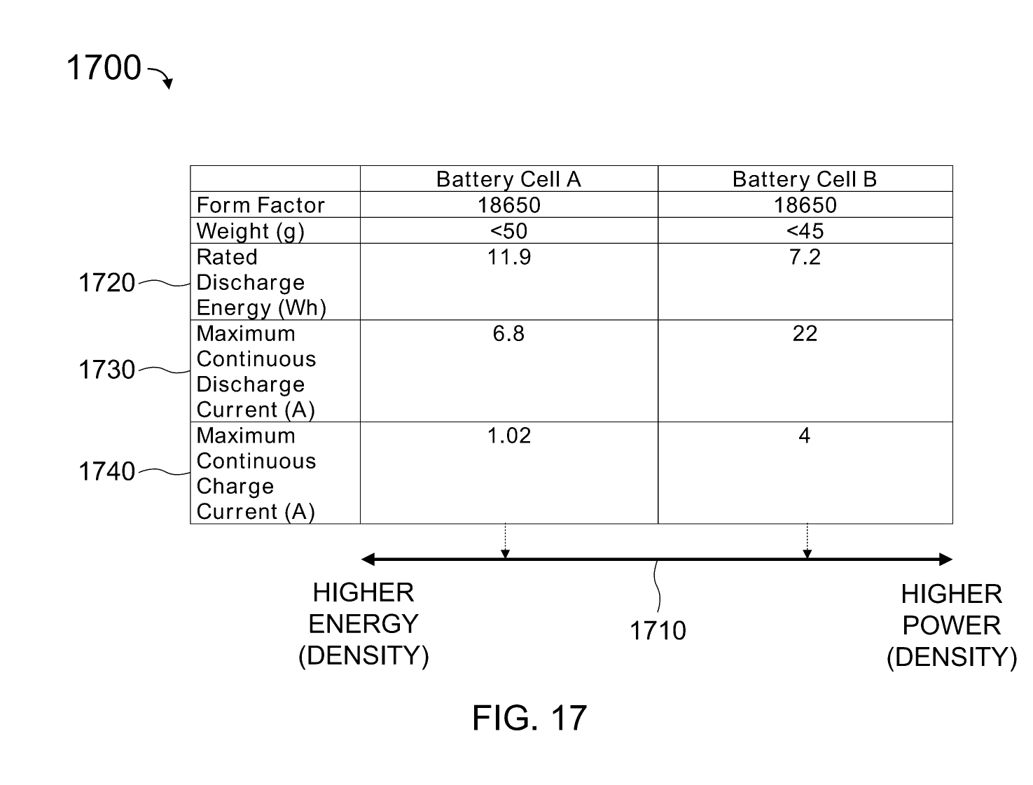

FIG. 17 shows a table 1700 of characteristics/specifications for example battery cells—battery cell A and battery cell B—which may be used in battery modules 210d (i.e., battery modules 210d_{1,1}

-210d_{x,y}). Generally, battery cells can reflect a tradeoff between (selection or balance of) high energy (density) or high power (density). The tradeoff is represented by continuum 1710 having higher energy (density) and higher power (density) at opposite ends.

Energy for battery cells A and B is illustrated in table 1700 in the Rated Discharge Energy (Wh) row 1720. As shown in FIG. 17, battery cell A is toward the higher energy (density) end of continuum 1710 and may be referred to as a “high energy” or “higher energy” battery cell. In general, energy refers to an amount of energy a battery cell (or battery module 210d or string 212a or battery pack 140_{C}) is capable of storing, such as measured in Watt hours (Wh). For example, higher energy battery cells (e.g., battery cell A) can be advantageous for portable electronics, where operation on battery power for a greater amount of time is desirable. Typically, an electric vehicle using high energy battery cells will beneficially travel farther on a charge than an electric vehicle using high power battery cells (e.g., battery cell B), all things being otherwise equal. In contrast, higher energy battery cells can have lower power, such that a discharge rate (e.g., rate at which a battery cell can provide energy) is slower (e.g., compared to battery cells having higher power, such as battery cell B).

Power for battery cells A and B is illustrated in table 1700 in the Maximum Continuous Discharge Current (A) row 1730. As shown in FIG. 17, battery cell B is toward the higher power (density) end of continuum 1710 and may be referred to as a “high power” or “higher power” battery cell. In general, power refers to an amount of energy a battery cell (or battery module 210d or string 212a or battery pack 140_{C}) is capable of (continuously) providing, such as a (load) current measured in Amperes (A). For example, higher power battery cells (e.g., battery cell B) can be advantageous for (hybrid) electric vehicles, where a faster discharge rate to provide electrical power to an electric motor is desirable. Typically, an electric vehicle using high power battery cells will beneficially accelerate faster than an electric vehicle using high energy battery cells, all things being otherwise equal. In contrast, battery cells having higher power can have lower energy, such that an amount of energy the battery cell can store is lower (e.g., compared to battery cells having higher energy, such as battery cell A).

Maximum continuous charge current for battery cells A and B is illustrated in table 1700 in the Maximum Continuous Charge Current (A) row 1740. A maximum continuous charge current is a maximum current a battery cell (or battery module 210d or string 212a or battery pack 140_{C}) may receive during charging. Charging is putting energy into a battery cell by providing an electric current. Charging can use different techniques, such as constant direct current (DC), pulsed DC, Constant-Voltage/Constant-Current (CV/CC), and the like charging. As shown in FIG. 17, maximum continuous discharge current (A) can correlate with maximum continuous charge current (A), and vice-versa. Typically, a higher maximum continuous charge current advantageously contributes to a shorter battery charging time, and a lower maximum continuous charge current undesirably contributes to a longer battery charging time. For example, longer battery charging times can result in more time needed to charge an electric vehicle's battery and potentially before the electric vehicle can be used again.

As shown in table 1700, battery cell A can have a 3.4 Ah (11.9 Wh) rated discharge energy (e.g., maximum capacity) and maximum continuous discharge current of 6.8 A (=2 C). A C-rate is a measure of the rate at which a battery is discharged relative to its maximum capacity. Here, battery cell A is rated 2 C, so the maximum continuous discharge current (e.g., 6.8 A) is twice the maximum capacity (e.g., 3.4 Ah). In contrast, battery cell B can have a 2.0 Ah (7.2 Wh) rated discharge energy (e.g., maximum capacity) and maximum continuous discharge current of 22 A (=11 C). By way of non-limiting example, battery cell A can be a Samsung SDI 36G cell and/or battery cell B can be a Samsung SDI 20R cell.

In some embodiments, battery cells A and B have substantially the same exterior dimensions (e.g., manufactured to the same or compatible exterior specification), although having different electrical specifications, such as energy and power. In various embodiments, battery cells A and B have substantially the same nominal voltage (e.g., designed and manufactured to the same or compatible output voltage specification, such as within a predetermined output voltage range), although having other different electrical specifications, such as energy and power. In exemplary embodiments, an output voltage of all strings 212a (i.e., strings 212a₁-212aₓ in FIG. 16) is substantially the same (e.g., within a predetermined output voltage range).

The two example battery cells—battery cells A and B—depicted in FIG. 17 are purely for illustrative purposes. Other battery cells having different specifications typifying the power and energy tradeoff may also be used.

In some embodiments, battery cells in strings 212a (i.e., strings 212a₁-212aₓ in FIG. 16) are homogeneous. For example, battery cells in strings 212a₁ through 212aₓ are all high energy battery cells (e.g., battery cell A) or all high power battery cells (e.g. battery cell B), but not both. Generally, use of homogeneous high energy battery cells or high power battery cells in an electric vehicle can offer either faster acceleration or greater travel distance, but not both.

In various embodiments, the battery cells in each of strings 212a (i.e., strings 212a₁-212aₓ in FIG. 16) comprise either high energy battery cells (e.g., battery cell A) and be referred to as a high energy string, or high power battery cells (e.g., battery cell B) and be referred to as a high power string. In this way, each of strings 212a can each offer the advantages of either high energy battery cells or high power battery cells.

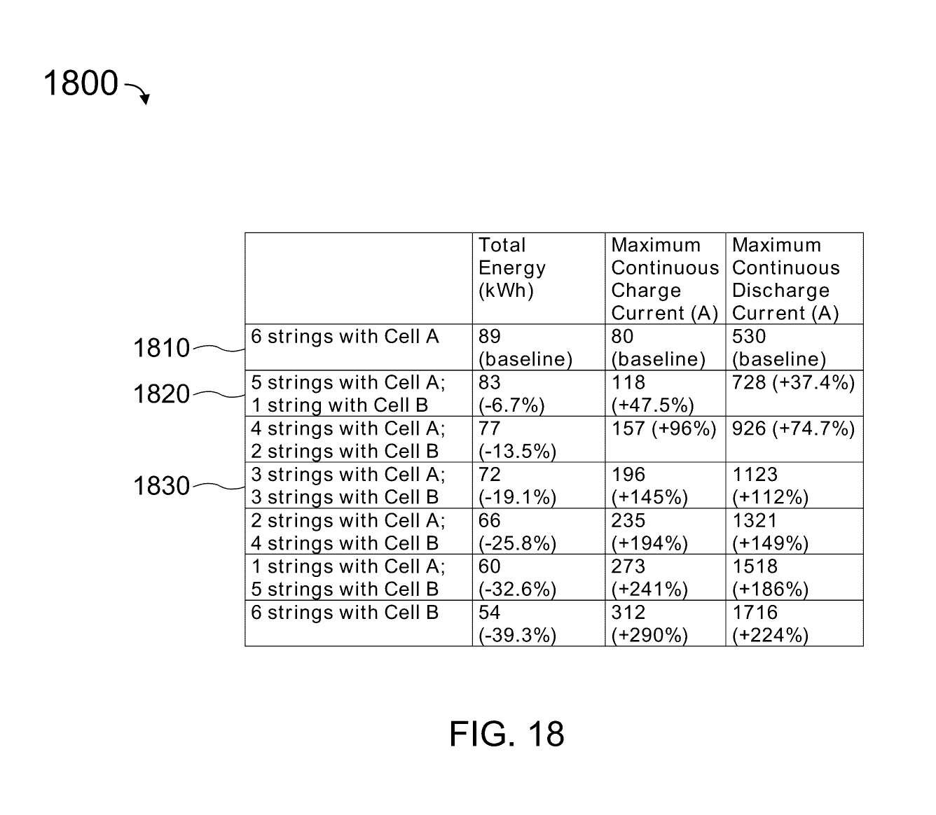

FIG. 18 shows a table 1800 of characteristics/specifications of battery pack 140_{C} in FIG. 16 for different example combinations of high energy strings and high power strings in battery pack 140_{C}. Purely for the purpose of illustration and not limitation, the examples of FIG. 18 have battery pack 140_{C} comprise six strings 212a₁-212a₆ (i.e., X=6); strings 212a₁-212a₆ each comprise six battery modules 210d_{1,1}-210d_{1,6}, 210d_{2,1}-210d_{2,6}, 210d_{3,1}-210d_{3,6}, 210d_{5,1}-210d_{5,6}, and 210d_{6,1}-210d_{6,6}, respectively (i.e., Y=6); and battery modules 210d_{1,1}-210d_{6,6} each comprise 208 battery cells for a total of 7,488 battery cells in battery pack 140_{C}.

By way of non-limiting example, table 1800 includes characteristics/specifications for different ratios of high energy strings to high power strings (i.e., 6:0 (100% high energy strings), 5:1, 4:2, 3:3 (50% high energy strings and 50% high power strings), 2:4, 1:5, and 0:6 (100% high power strings)). For example, row 1810 depicts an embodiment where battery pack 140_{C} in FIG. 16 has high energy cells in all six strings 212a₁-212a₆ (i.e., 6:0 ratio) and has a total energy of 89 kWh. Row 1820 shows another example where battery pack 140_{C} has five high energy strings and one high power string (i.e., 5:1 ratio) and has a total energy of 83 kWh. When the output voltage of strings 212a₁-212a₆ is substantially the same (e.g., 350 V±a predetermined tolerance), a change in configuration of battery pack 140_{C} from a 6:0 ratio to a 5:1 ratio yields a 6.7% loss in total energy, a 37.4% improvement in the maximum continuous discharge current (i.e., from 530 A to 728 A), and a 47.5% increase in maximum continuous charge current. In some embodiments, a particular ratio of high energy strings to high power strings is selected to balance energy and power in battery pack 140_{C} to suit different vehicle use-models or applications, such as high performance (e.g., quicker acceleration) and energy economy (e.g., greater mileage/travel distance per charge).

Other numbers of strings and numbers of modules per string may also be used. Other ratios of high energy strings to high power strings may also be used. Generally, using one type of high power battery cell and one type of high energy battery (as opposed to more than two types of battery cells along continuum 1710 in FIG. 17) yields enough combinations to suitably trade off high power and high energy for particular applications, such as high performance and energy economy. Moreover, using fewer battery types (e.g., two) can advantageously avoid higher costs arising from procuring, stocking, and the like a greater number of battery cell types.

In some embodiments, high energy strings are disposed together on one end of battery pack 140_{C} and high power strings are disposed together at the opposite end of battery pack 140_{C}. For example, for the configuration illustrated by row 1830 of table 1800 (i.e., 3:3 ratio), strings 212a₁-212a₃ can be high energy strings and strings 212a₄-212a₆ can be high power strings, or strings 212a₁-212a₃ can be high power strings and strings 212a₄-212a₆ can be high energy strings.

In various embodiments, high energy strings are interleaved with high power strings in battery pack 140_{C}. For example, for the configuration illustrated by row 1830 of table 1800 (i.e., 3:3 ratio), strings 212a₁, 212a₃, and 212a₅ can be high energy strings and strings 212a₂, 212a₄, and 212a₆ can be high power strings, or strings 212a₁, 212a₃, and 212a₅ can be high power strings and strings 212a₂, 212a₄, and 212a₆ can be high energy strings.

Other arrangements of high energy strings and high power strings may be used. By way of non-limiting example, strings 212a_{1, 212}a_{2, and 212}a₄ can be high energy strings and strings 212a₃, 212a₅, and 212a₆ can be high power strings, or strings 212a₁, 212a₂, and 212a₄ can be high power strings and strings 212a₃, 212a₅, and 212a₆ can be high energy strings.

As would be readily appreciated by one of ordinary skill in the art, various embodiments described herein may be used in additional applications, such as in energy-storage systems for wind and solar power generation. Other applications are also possible.

The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

1. A heterogeneous battery pack comprising:
a first plurality of strings electrically coupled to each other in parallel, each of the first plurality of strings providing substantially a first output voltage and comprising:
a first plurality of battery modules electrically coupled to each other in series, each of the first plurality of battery modules providing substantially a second output voltage and comprising:
a substantially homogeneous set of high power battery cells, each of the plurality of high power battery cells providing substantially a third output voltage and having a higher discharge rate and lower charge storage capacity than a substantially homogeneous set of high energy battery cells; and
a second plurality of strings electrically coupled to each other and to the first plurality of strings in parallel, each of the second plurality of strings providing substantially the first output voltage and comprising:
a second plurality of battery modules electrically coupled to each other in series, each of the second plurality of battery modules providing substantially the second output voltage and comprising:
the substantially homogeneous set of high energy battery cells, each of the plurality of high energy battery cells providing substantially the third output voltage and having a higher charge storage capacity and lower discharge rate than the substantially homogeneous set of high power battery cells.

2. The heterogeneous battery pack of claim 1, wherein a ratio of a first number of strings in the first plurality of strings to a second number of strings in the second plurality of strings is such that the heterogeneous battery pack has a higher energy than another homogeneous battery pack comprising only high power battery cells.

3. The heterogeneous battery pack of claim 1, wherein a first number of strings in the first plurality of strings is equal to a second number of strings in the second plurality of strings.

4. The heterogeneous battery pack of claim 1, wherein a ratio of a first number of strings in the first plurality of strings to a second number of strings in the second plurality of strings is such that the heterogeneous battery pack has a higher power than another homogeneous battery pack comprising only high energy battery cells.

5. The heterogeneous battery pack of claim 1, wherein the plurality of high power battery cells and the plurality of high energy battery cells comprise respective rechargeable lithium-ion battery cells.

6. The heterogeneous battery pack of claim 5, wherein exterior dimensions of each of the plurality of high power battery cells and each of the plurality of high energy battery cells correspond to an 18650 battery cell.

7. The heterogeneous battery pack of claim 1, wherein each of the first and the second plurality of battery modules comprises at least two hundred high power battery cells and high energy battery cells, respectively.

8. The heterogeneous battery pack of claim 7, wherein each of the first and the second plurality of strings comprises at least three first battery modules and at least three second battery modules, respectively.

9. The heterogeneous battery pack of claim 8, wherein a first number of strings in the first plurality of strings and a second number of strings in the second plurality of strings are each at least three.

10. The heterogeneous battery pack of claim 1 further comprising a liquid cooling system thermally coupled to each high power battery cell of the plurality of high power battery cells and each high energy battery cell of the plurality of high energy battery cells.

11. A heterogeneous battery pack comprising:
a first plurality of strings electrically coupled to each other in parallel, each of the first plurality of strings providing substantially a first output voltage and comprising:
a first plurality of battery modules electrically coupled to each other in series, each of the first plurality of battery modules providing substantially a second output voltage and comprising:
two first half modules, each of the two first half modules electrically coupled to each other and comprising:
a substantially homogeneous set of high power battery cells, each of the plurality of high power battery cells providing substantially a third output voltage and having a higher discharge rate and lower charge storage capacity than a substantially homogeneous set of high energy battery cells; and
a second plurality of strings electrically coupled to each other and to the first plurality of strings in parallel, each of the second plurality of strings providing substantially the first output voltage and comprising:
a second plurality of battery modules electrically coupled to each other in series, each of the second plurality of battery modules providing substantially the second output voltage and comprising:
two second half modules, each of the two second half modules electrically coupled to each other and comprising:
the substantially homogeneous set of high energy battery cells, each of the plurality of high energy battery cells providing substantially the third output voltage and having a higher charge storage capacity and lower discharge rate than the substantially homogeneous set of high power battery cells.

12. The heterogeneous battery pack of claim 11, wherein a ratio of a first number of strings in the first plurality of strings to a second number of strings in the second plurality of strings is such that the heterogeneous battery pack has a higher energy than another homogeneous battery pack comprising only high power battery cells.

13. The heterogeneous battery pack of claim 11, wherein a first number of strings in the first plurality of strings is equal to a second number of strings in the second plurality of strings.

14. The heterogeneous battery pack of claim 11, wherein a ratio of a first number of strings in the first plurality of strings to a second number of strings in the second plurality of strings is such that the heterogeneous battery pack has a higher power than another homogeneous battery pack comprising only high energy battery cells.

15. The heterogeneous battery pack of claim 11, wherein the plurality of high power battery cells and the plurality of high energy battery cells comprise respective rechargeable lithium-ion battery cells.

16. The heterogeneous battery pack of claim 15, wherein exterior dimensions of each of the plurality of high power battery cells and each of the plurality of high energy battery cells correspond to an 18650 battery cell.

17. The heterogeneous battery pack of claim 11, wherein each of the first and the second plurality of battery modules comprises at least two hundred high power battery cells and high energy battery cells, respectively.

18. The heterogeneous battery pack of claim 17, wherein each of the first and the second plurality of strings comprises at least three first battery modules and at least three second battery modules, respectively.

19. The heterogeneous battery pack of claim 18, wherein a first number of strings in the first plurality of strings and a second number of strings in the second plurality of strings are each at least three.

20. (canceled)
